(19) United States
(12) Patent Application Publication
(10) Pub. No.: US 2009/0149167 A1
(43) Pub. Date: Jun. 11, 2009

(54) CONNECTED PORTFOLIO SERVICES FOR A WIRELESS COMMUNICATIONS NETWORK

(75) Inventors: Krishnakant M. Patel, Richardson, TX (US); Gorachand Kundu, Bangalore (IN); Ravi Ayyasamy, Richardson, TX (US); Bruce D. Lawler, Kirkwood, CA (US); Ravi Shankar Kumar, Plano, TX (US); Harisha Mahabaleshwara Negalaguli, Plano, TX (US); Basem Ahmad Ardah, Plano, TX (US); Pratap Chandana, Plano, TX (US); Shan-Jen Chiou, Plano, TX (US); Arun Velayudhan, Bangalore (IN); Ramu Kandula, Bangalore (IN)

Correspondence Address: GATES & COOPER LLP;HOWARD HUGHES CENTER, 6701 CENTER DRIVE WEST, SUITE 1050, LOS ANGELES, CA, 90045, US

(73) Assignee: KODIAK NETWORKS, INC., Plano, TX (US)

(21) Appl. No.: 12/259,102

(22) Filed: Oct. 27, 2008

Related U.S. Application Data
(60) Provisional application No. 60/982,650, filed on Oct. 25, 2007.
(60) Provisional application No. 61/023,042, filed on Jan. 23, 2008.

(51) Int. Cl. H04M 3/42

(52) U.S. Cl. 455/416

(57) ABSTRACT

Connected Portfolio Services for use in a mobile phone network include new mobile phone services: Scheduled Conference with Dial-Out and Dial-In modes of operation; Reservationless Conference; Instant Conferencing; Group Short Message Service with Reply All; Voice Short Message Service with Reply All; Family Connect; Buddy Connect; Quick Reach; and Email2Conference. Connected Portfolio Services also include a new handset client application, management of a limited pool of network routable numbers, and a prepaid billing solution.

### CROSS REFERENCE TO RELATED APPLICATIONS

This application claims the benefit under 35 U.S.C. Section 119(e) of the following co-pending and commonly-assigned patent application:

U.S. Provisional Application Ser. No. 60/982,650, filed on Oct. 25, 2007, by Krishnakant M. Patel, Gorachand Kundu, and Ravi Ayyasamy, entitled “INTERACTIVE, VIRAL GROUP COMMUNICATIONS IN A WIRELESS COMMUNICATIONS NETWORK,” attorneys' docket number 154.32-US-P1, and

U.S. Provisional Application Ser. No. 61/023,042, filed on Jan. 23, 2008, by Krishnakant M. Patel, Gorachand Kundu, and Ravi Ayyasamy, entitled “SYSTEM ARCHITECTURE FOR CONNECTED PORTFOLIO SERVICES,” attorneys' docket number 154.32-US-P2,

which applications are incorporated by reference herein.

This application is related to the following co-pending and commonly-assigned patent applications:

U.S. Utility application Ser. No. 10/515,556, filed Nov. 23, 2004, by Gorachand Kundu, Ravi Ayyasamy and Krishnakant Patel, entitled “DISPATCH SERVICE ARCHITECTURE FRAMEWORK,” attorney docket number G&C 154.4-US-WO, which application claims the benefit under 35 U.S.C. Section 365 of P.C.T. International Application Serial Number PCT/US03/16386 (154.4-WO-U1), which application claims the benefit under 35 U.S.C. Section 119(e) of U.S. Provisional Application Ser. Nos. 60/382,981 (154.3-US-P1), 60/383,179 (154.4-US-P1) and 60/407,168 (154.5-US-P1);

U.S. Utility application Ser. No. 10/564,903, filed Jan. 17, 2006, by F. Craig Farrill, Bruce D. Lawler and Krishnakant M. Patel, entitled “PREMIUM VOICE SERVICES FOR WIRELESS COMMUNICATIONS SYSTEMS,” attorney docket number G&C 154.7-US-WO, which application claims the benefit under 35 U.S.C. Section 365 of P.C.T. International Application Serial Number PCT/US04/23038 (154.7-WO-U1), which application claims the benefit under 35 U.S.C. Section 119(e) of U.S. Provisional Application Ser. Nos. 60/488,638 (154.7-US-P1), 60/492,650 (154.8-US-P1) and 60/576,094 (154.14-US-P1) and which application is a continuation-in-part and claims the benefit under 35 U.S.C. Sections 119, 120 and/or 365 of P.C.T. International Application Serial Number PCT/US03/16386 (154.4-WO-U1);

U.S. patent application Ser. No. 11/126,587, filed May 11, 2005, by Ravi Ayyasamy and Krishnakant M. Patel, entitled “ARCHITECTURE, CLIENT SPECIFICATION AND APPLICATION PROGRAMMING INTERFACE (API) FOR SUPPORTING ADVANCED VOICE SERVICES (AVS) INCLUDING PUSH TO TALK ON WIRELESS HANDSETS AND NETWORKS,” attorney docket number 154.9-US-U1, which application claims the benefit under 35 U.S.C. Section 119(e) of U.S. Provisional Application Ser. Nos. 60/569,953 (154.9-US-P1) and 60/579,309 (154.15-US-P1), and which application is a continuation-in-part and claims the benefit under 35 U.S.C. Sections 119, 120 and/or 365 of U.S. Utility application Ser. No. 10/515,556 (154.4-US-WO) and P.C.T. International Application Serial Number PCT/US04/23038 (154.7-WO-U1);

U.S. Utility application Ser. No. 11/129,268, filed May 13, 2005, by Krishnakant M. Patel, Gorachand Kundu, Ravi Ayyasamy and Basem Ardah, entitled “ROAMING GATEWAY FOR SUPPORT OF ADVANCED VOICE SERVICES WHILE ROAMING IN WIRELESS COMMUNICATIONS SYSTEMS,” attorney docket number 154.10-US-U1, now U.S. Pat. No. 7,403,775, issued Jul. 22, 2008, which application claims the benefit under 35 U.S.C. Section 119(e) of U.S. Provisional Application Ser. No. 60/571,075 (154.10-US-P1), and which application is a continuation-in-part and claims the benefit under 35 U.S.C. Sections 119, 120 and/or 365 of U.S. Utility application Ser. No. 10/515,556 (154.4-US-WO) and P.C.T. International Application Serial Number PCT/US04/23038 (154.7-WO-U1);

U.S. Utility application Ser. No. 11/134,883, filed May 23, 2005, by Krishnakant Patel, Vyankatesh V. Shanbhag, Ravi Ayyasamy, Stephen R. Horton and Shan-Jen Chiou, entitled “ADVANCED VOICE SERVICES ARCHITECTURE FRAMEWORK,” attorney docket number 154.11-US-U1, which application claims the benefit under 35 U.S.C. Section 119(e) of U.S. Provisional Application Ser. Nos. 60/573,059 (154.11-US-P1) and 60/576,092 (154.12-US-P1), and which application is a continuation-in-part and claims the benefit under 35 U.S.C. Sections 119, 120 and/or 365 of U.S. Utility application Ser. No. 10/515,556 (154.4-US-WO), P.C.T. International Application Serial Number PCT/US04/23038 (154.7-WO-U1), U.S. Utility application Ser. No. 11/126,587 (154.9-US-U1), and U.S. Utility application Ser. No. 11/129,268 (154.10-US-U1);

U.S. Utility application Ser. No. 11/136,233, filed May 24, 2005, by Krishnakant M. Patel, Vyankatesh Vasant Shanbhag, and Anand Narayanan, entitled “SUBSCRIBER IDENTITY MODULE (SIM) ENABLING ADVANCED VOICE SERVICES (AVS) INCLUDING PUSH-TO-TALK, PUSH-TO-CONFERENCE AND PUSH-TO-MESSAGE ON WIRELESS HANDSETS AND NETWORKS,” attorney docket number 154.13-US-U1, which application claims the benefit under 35 U.S.C. Section 119(e) of U.S. Provisional Application Ser. No. 60/573,780 (154.13-US-P1), and which application is a continuation-in-part and claims the benefit under 35 U.S.C. Sections 119, 120 and/or 365 of U.S. Utility application Ser. No. 10/515,556 (154.4-US-WO), P.C.T. International Application Serial Number PCT/US04/23038 (154.7-WO-U1), U.S. Utility application Ser. No. 11/126,587 (154.9-US-U1), and U.S. Utility application Ser. No. 11/134,883 (154.11-US-U1);

U.S. Utility application Ser. No. 11/158,527, filed Jun. 22, 2005, by F. Craig Farrill, entitled “PRESS-TO-CONNECT FOR WIRELESS COMMUNICATIONS SYSTEMS,” attorney docket number 154.16-US-U1, which application claims the benefit under 35 U.S.C. Section 119(e) of U.S. Provisional Application Ser. No. 60/581,954 (154.16-US-P1), and which application is a continuation-in-part and claims the benefit under 35 U.S.C. Sections 119, 120 and/or 365 of U.S. Utility application Ser. No. 10/515,556 (154.4-US-WO) and P.C.T. International Application Serial Number PCT/US04/23038 (154.7-WO-U1);

U.S. Utility application Ser. No. 11/183,516, filed Jul. 18, 2005, by Deepankar Biswaas, entitled “VIRTUAL PUSH TO TALK (PTT) AND PUSH TO SHARE (PTS) FOR WIRELESS COMMUNICATIONS SYSTEMS,” attorney docket number 154.17-US-U1, which application claims the benefit under 35 U.S.C. Section 119(e) of U.S. Provisional Application Ser. No. 60/588,464 (154.17-US-P1);

U.S. Utility application Ser. No. 11/356,775, filed Feb. 17, 2006, by Krishnakant M. Patel, Bruce D. Lawler, Giridhar K. Boray, and Brahmananda R. Vempati, entitled “ENHANCED FEATURES IN AN ADVANCED VOICE SERVICES (AVS) FRAMEWORK FOR WIRELESS COMMUNICATIONS SYSTEMS,” attorney docket number 154.18-US-U1, which application claims the benefit under 35 U.S.C. Section 119(e) of U.S. Provisional Application Ser. No. 60/654,271(154.18-US-P1);

P.C.T. International Application Serial Number PCT/US2006/011628, filed Mar. 30, 2006, by Krishnakant M. Patel, Gorachand Kundu, Sameer Dharangaonkar, Giridhar K. Boray, and Deepankar Biswas, entitled “TECHNIQUE FOR IMPLEMENTING ADVANCED VOICE SERVICES USING AN UNSTRUCTURED SUPPLEMENTARY SERVICE DATA (USSD) INTERFACE,” attorney docket number 154.19-WO-U1, which application claims the benefit under 35 U.S.C. Section 119(e) of U.S. Provisional Application Ser. No. 60/666,424 (154.19-US-P1);

U.S. Utility application Ser. No. 11/462,332, filed Aug. 3, 2006, by Deepankar Biswas, Krishnakant M. Patel, Giridhar K. Boray, and Gorachand Kundu, entitled “ARCHITECTURE AND IMPLEMENTATION OF CLOSED USER GROUP AND LIMITING MOBILITY IN WIRELESS NETWORKS,” attorney docket number 154.20-US-U1, which application claims the benefit under 35 U.S.C. Section 119(e) of U.S. Provisional Application Ser. No. 60/705,115 (154.20-US-P1);

U.S. Utility application Ser. No. 11/463,186, filed Aug. 8, 2006, by Ravi Ayyasamy and Krishnakant M. Patel, entitled “ADVANCED VOICE SERVICES CLIENT FOR BREW PLATFORM,” attorney docket number 154.21-US-U1, which application claims the benefit under 35 U.S.C. Section 119(e) of U.S. Provisional Application Ser. No. 60/706,265 (154.21-US-P1);

U.S. Utility application Ser. No. 11/567,098, filed Dec. 5, 2006, by Ravi Ayyasamy, Bruce D. Lawler, Krishnakant M. Patel, Vyankatesh V. Shanbhag, Brahmananda R. Vempati, and Ravi Shankar Kumar, entitled “INSTANT MESSAGING INTERWORKING IN AN ADVANCED VOICE SERVICES (AVS) FRAMEWORK FOR WIRELESS COMMUNICATIONS SYSTEMS,” attorney docket number 154.23-US-U1, which application claims the benefit under 35 U.S.C. Section 119(e) of U.S. Provisional Application Ser. No. 60/742,250 (154.23-US-P1); and

U.S. Utility application Ser. No. 11/740,805, filed Apr. 26, 2007, by Krishnakant M. Patel, Giridhar K. Boray, Ravi Ayyasamy, and Gorachand Kundu, entitled “ADVANCED FEATURES ON A REAL-TIME EXCHANGE SYSTEM,” attorney docket number 154.26-US-U1, which application claims the benefit under 35 U.S.C. Section 119(e) of U.S. Provisional Application Ser. No. 60/795,090 (154.26-US-P1);

U.S. Utility application Ser. No. 11/891,127, filed Aug. 9, 2007, by Krishnakant M. Patel, Deepankar Biswas, Sameer P. Dharangaonkar and Terakanambi Nanjanayaka Raja, entitled “EMERGENCY GROUP CALLING ACROSS MULTIPLE WIRELESS NETWORKS,” attorney docket number 154.27-US-U1, which application claims the benefit under 35 U.S.C. Section 119(e) of U.S. Provisional Application Ser. No. 60/836,521 (154.27-US-P1);

all of which applications are incorporated by reference herein.

### BACKGROUND OF THE INVENTION

1. Field of the Invention

This invention relates in general to wireless communications systems, and more specifically, to connected portfolio services for wireless networks.

2. Description of Related Art

Advanced Voice Services (AVS), also known as Advanced Group Services (AGS), such as two-way half-duplex voice calls within a group, also known as Push-to-Talk (PTT) or Press-to-Talk (P2T), as well as other AVS functions, such as Push-to-Conference (P2C) or Instant Conferencing, Push-to-Message (P2M), etc., are described in the co-pending and commonly-assigned patent applications cross-referenced above and incorporated by reference herein. These AGS functions have enormous revenue earnings potential for wireless communications systems, such as mobile phone networks.

Currently, there are three major approaches employed in providing PTT or P2T in wireless communications systems. One approach requires the installation of a dedicated private network, parallel to the wireless communications system, to support the group-based voice services. NEXTEL uses such a system, based on a solution developed by MOTOROLA known as IDEN. However, a dedicated private network is costly to install and maintain and is employed by a few public wireless carriers. Also, the IDEN system is non-standard, and hence cannot be used in standard wireless communications networks, such as those based on GSM (Global System for Mobile Communications) and CDMA (Code Division Multiple Access).

Another approach is based on Voice over IP (VoIP) technologies. While this approach promises compliance with newer and emerging standards, such as GPRS (General Packet Radio Service), UMTS (Universal Mobile Telecommunications System), etc., it does not provide a solution for carriers employing wireless communications systems based on existing standards, such as GSM, CDMA, etc. However, even for the newer standards, solutions based on VoIP have serious drawbacks, including slower call setup, significant overhead, increased susceptibility to packet losses, low bit rate voice coders, and significant modifications to the mobile handset.

Still another approach is the innovative approach described in the co-pending and commonly-assigned patent applications cross-referenced above and incorporated by reference herein. In this approach, advanced voice services are provided by a real-time exchange (RTX), also known as a dispatch gateway (DG), that interfaces to the wireless communications system to provide the advanced voice services therein, wherein both the real-time exchange and mobiles that use the advanced voice services communicate with each other using call setup and in-band signaling within the wireless communications system.

However, notwithstanding the innovations described in the co-pending and commonly-assigned patent applications cross-referenced above, there is a need in the art for improvements to these advanced voice services, as well as additional advanced voice services, that comply with existing and emerging wireless standards and provide superior user experiences. The present invention aims to satisfy this need by providing improved group-based communications services, known as Connected Portfolio Services, for wireless communications systems.

### SUMMARY OF THE INVENTION

To overcome the limitations in the prior art described above, and to overcome other limitations that will become apparent upon reading and understanding the present specification, the present invention discloses Connected Portfolio Services for use in a mobile phone network. The Connected Portfolio Services include Scheduled Conference with Dial-Out and Dial-In modes of operation; Reservationless Conference; Instant Conferencing; Group Short Message Service with Reply All; and Voice Short Message Service with Reply All. These services may be implemented through the management of a limited pool of network routable numbers. These and other aspects of the present invention are described in more detail below.

### BRIEF DESCRIPTION OF THE DRAWINGS

Referring now to the drawings in which like reference numbers represent corresponding parts throughout:

FIG. 1 is a block diagram that illustrates an exemplary embodiment of a wireless communications network according to a preferred embodiment of the present invention.

FIG. 2 illustrates a proposed architecture for a Real-Time Exchange according to the preferred embodiment of the present invention.

FIG. 3 illustrates the high-level functional components and their interfaces in a mobile station or handset according to a preferred embodiment of the present invention.

FIG. 4 illustrates the user interface for the conference scheduler as displayed on the handset.

FIG. 5 is a flowchart that illustrates the steps performed in a Scheduled Conference.

FIG. 6 is a call flow diagram that illustrates the steps performed in a Conference Call via Dial-Out in a CDMA network.

FIG. 7 is a call flow diagram that illustrates the steps performed in a Conference Call via Dial-In in a CDMA network.

FIG. 8 is a call flow diagram that illustrates the steps performed in a Conference Call Creation.

FIG. 9 is a call flow diagram that illustrates the steps performed in a Conference Call via Dial-Out in a GSM network.

FIG. 10 is a call flow diagram that illustrates the steps performed in a Conference Call via Dial-In in a GSM network.

FIG. 11 is a call flow diagram that illustrates the steps performed in a Conference Call Creation.

FIG. 12 is a flowchart that illustrates the steps performed in a Reservationless Conference Origination.

FIG. 13 is a flowchart that illustrates the steps performed in Clientless Group Creation.

FIG. 14 is a flowchart that illustrates the steps performed in placing a mobile conference call with the clientless group.

FIG. 15 is a flowchart that illustrates the steps performed in placing a mobile conference call using a client application.

FIG. 16 is a flowchart that illustrates the steps performed in Group Short Message Service with Reply All.

FIG. 17 is a call flow diagram that depicts the Group Short Message Service initiated by a postpaid user in a CDMA network.

FIG. 18 is a call flow diagram that depicts the Group Short Message Service initiated by a prepaid user in a CDMA network.

FIG. 19 is a call flow diagram that depicts the Group Short Message Service initiated by a postpaid user in a GSM network.

FIG. 20 is a call flow diagram that depicts the Group Short Message Service initiated by a prepaid user in a GSM network.

FIG. 21 is a flowchart that illustrates the steps performed when a user invokes a (star) dialing option to send a Voice Short Message Service to a single recipient.

FIG. 22 is a flowchart that illustrates the steps performed in a 1-to-many Voice Short Message Service to a group of recipients.

FIG. 23 is a flowchart that illustrates the steps performed when a user invokes Voice Short Message Service from a handset provisioned with a client application.

FIG. 24 is a call flow diagram that depicts the Voice Short Message Service deposit without report in a CDMA network.

FIG. 25 is a call flow diagram that depicts the Voice Short Message Service retrieval followed by a Reply All option in a CDMA network.

FIG. 26 is a call flow diagram that depicts the Voice Short Message Service deposit without report in a GSM network.

FIG. 27 is a call flow diagram that depicts the Voice Short Message Service retrieval followed by a Reply All option in a GSM network.

### DETAILED DESCRIPTION OF THE INVENTION

In the following description of the preferred embodiment, reference is made to the accompanying drawings which form a part hereof, and in which is shown by way of illustration the specific embodiment in which the invention may be practiced. It is to be understood that other embodiments may be utilized as structural changes may be made without departing from the scope of the present invention.

### 1 Overview

1.1 Connected Portfolio Services for a Wireless Communications Network

The present invention discloses Connected Portfolio Services for a wireless communications network, as well as a suite of applications, both within the network and within the mobile handsets used in the network, that provide these services. The innovative features of these services and applications include the following:

1. Scheduled Conference: This service allows a mobile handset user to schedule a conference with a group of other users at a predetermined date and time. There are two modes of operation: Dial-Out and Dial-In:

a) Dial-Out: In this option, a Real-Time Exchange (RTX) will dial out the call to participants in a scheduled conference, and then bridge the conference call between the participants.

b) Dial-In: In this option, participants in a scheduled conference dial in to a conference bridge number.

A number of unique technologies are provided to facilitate the Scheduled Conference service with many user friendly features, such as conference call notification, one-touch dial to join a conference call, etc.

2. Reservationless Conference: This service allows a user to set up a conference bridge and communicate the conference bridge access number and password to participants of a conference call. This solution is “clientless” in that the originator does not need a handset client application to invoke this service.

3. Instant Conferencing: This service allows users to create and manage groups using multiple different means, such as via the Web, via Short Message Service (SMS), via Wireless Access Protocol (WAP), via an operator, etc. Once a group is created, the originator receives a single dial out number; upon dialing this number, the originator is connected to the group.

4. Group SMS (GSMS) with Reply All: The Group SMS service allows a user to simultaneously send a text message to a list of participants. Upon receiving the message, each of the recipients may reply to the originator or reply all to the entire list of participants.

5. Voice SMS (VSMS) with Reply All: Voice SMS is an “Instant Voice Messaging” service that allows a user to deposit a single voice message for retrieval by a group of recipients, without actually calling each of the recipients. Upon retrieving the message, each of the recipients may reply to the originator or reply all to the entire list of participants.

6. Management of a Limited Pool of Network Routable Numbers: This service describes a method for allocating one number from a pool of network routable numbers for each participant in a particular session of group-based communications services, such that each number uniquely identifies a session context for a given participant with an identifier. With this allocation strategy, group communications becomes viral and interactive, as any addressable number in any type of network can be a participant to a group-based communications services session of voice, video and text hosted by the RTX. Allocation and management of a limited pool of network routable numbers is important, as these are scarce resources, yet service providers would like to provide group-based communications services to an arbitrarily large number of users.

7. Handset Client Application: An innovative handset client application has been developed so that large number of mobile handset users can experience the advanced suite of group communications products described herein. The client applications are available on multiple popular operating systems, such as JAVA, WINDOWS MOBILE, SYMBIAN and BREW. These client applications are implemented for popular cellular standards, such as CDMA and GSM, but are equally applicable to other standards, including newer emerging standards, as well.

8. Family Connect: The Family Connect service allows user to make an instant conference call to all the family members. It can utilize the operator's existing family plan database instead of creating its own database.

9. Buddy Connect: The Buddy Connect service allows a user to create a buddy group and make an instant conference by any buddy member in the buddy group.

10. Quick Reach: The Quick Reach service is a call originating service that allows a user to create a list of phone numbers in order to reach a particular person. When the user originates this type of call, all the phones for that particular person are called and rang until one of the phones answers the call, and then the rest of call attempts are dropped.

11. Email2Conference: The Email2Conference service enables the initiation of a mobile conference request from any standard email/calendar client application that can run on desktop computers or mobile handsets.

12. Prepaid Billing Solution: The Prepaid Billing Solution service enables a real-time billing mechanism for a prepaid subscriber.

### 2 System Description

2.1 Overview

The following illustration explains the network reference architecture used to provide the Connected Portfolio Services described herein. These Connected Portfolio Services are provided without any changes to the existing network infrastructure, but merely the addition of a service control point, known as a Real-Time Exchange (RTX), connected to the network and a client application embedded in the handset (although a clientless version is provided as well).

2.2 Network Architecture

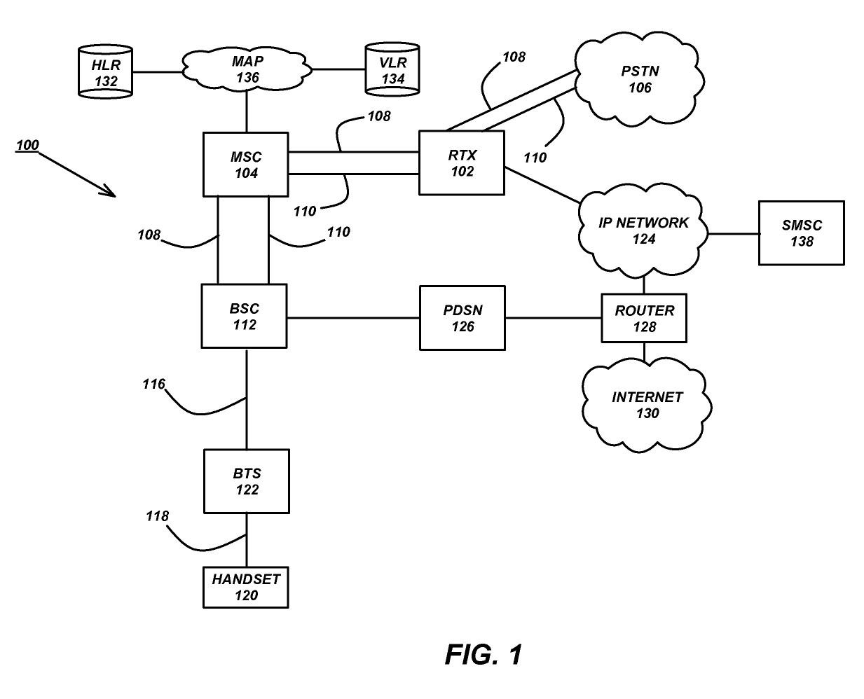

FIG. 1 is a block diagram that illustrates an exemplary embodiment of a wireless communications network according to a preferred embodiment of the present invention.

Within the network 100, an RTX 102, also known as a Dispatch Gateway (DG), communicates with a MSC (Mobile Switching Center) 104 and PSTN (Public Switched Telephone Network) 106 using SS7-ISUP/WIN/CAMEL (Signaling System 7-Integrated Services Digital Network User Part/Wireless Intelligent Network/Customized Applications for Mobile Enhanced Logic) messages at a signaling plane 108. A bearer path 110 implements a TDM (Time Division Multiplexing) interface carrying PCM (Pulse Code Modulation) or TFO (Tandem Free Operation) voice frames. Support for TFO in this path 110 is negotiated between a BSC (Base Station Controller) 112 and the RTX 102 for each originating and terminating leg of an AGS call. The use of TFO ensures high voice quality (as voice vocoder conversion is avoided) between mobile-to-mobile calls.

When a subscriber originates an AGS call, the MSC 104 routes the call to the RTX 102. The MSC 104 also requests the BSC 112 via 116 to establish a radio traffic path 118 with a mobile station (MS) 120 (also known as a handset or mobile unit) via the BTS (Base Transceiver Station) 122 (as it does for a normal cellular call). At this time, the BSC 112 tries to negotiate TFO (if it is supported) on a TDM link with the far end (in this case, the RTX 102).

At the same time (after the MSC 104 terminates the group call request to the RTX 102), the RTX 102 identifies the terminating group users and their numbers, which may comprise an MS-ISDN (Mobile Station-Integrated Services Digital Network) number, an IMSI (International Mobile Subscriber Identity) number, or an MDN (Mobile Directory Number).

The RTX 102 sends an ISUP call origination request for each terminating MS 120. It may send requests directly to the MSC 104, PSTN 106 or IP network 124 via a PDSN (Public Data Switched Network) 126, Router 128, and/or Internet/Intranet 130, depending on the routing table configuration for terminating numbers. Once the bearer path 110 is established, the RTX 102 begins a negotiation with the far end (in this case, the terminating BSC 112) for each terminating leg to an MS 120.

Once bearer paths 110 are established for originating and terminating legs for an AGS call, the RTX 102 switches (or duplicates) voice or data from the originating MS 120 to all terminating MS's 120.

The RTX 102 may also use an IP network 124 or the Internet/Intranet 130. The IP network 124 or the Internet/Intranet 130 can be used in a toll bypass mode where two RTXs 102 can exchange voice traffic bypassing the PSTN 106. However, each RTX 102 is responsible for terminating traffic to its closest MSC 104. In this case, the IP network 124 or the Internet/Intranet 130 is used as a backbone transport of voice traffic between two RTXs 102.

The IP network 124 or the Internet/Intranet 130 can also be used for a registration and presence application. Since the MSC 104 will not direct a registration request from a MS 120 to the RTX 102 (because it would require changes in the MSC 104), the latter does not have any information of the registered MS 120. To circumvent this issue, a registration and presence application runs over an IP stack in the MS 120. After the MS 120 registers for a data interface (i.e., obtaining an IP address) with the PDSN 126 (or Serving GSM Service Nodes (SGSN) in the case of GSM networks), the registration and presence application in the MS 120 registers with the RTX 102 using its IP address. The RTX 102 also uses this IP interface to update the presence information of other group members to an MS 120.

An alternative embodiment may use the SMS (Short Message Service) transport to carry presence messages over a data channel. The RTX 102 interacts with the MS 120 using predefined presence application related messages that are transported as SMS messages. The same messages can be transported via the PDSN 126 interface, if group users have data service.

During roaming, a Home Location Register (HLR) 132 and Visitor Location Register (VLR) 134 can be accessed via the MSC 104 and a MAP link 136. The HLR 132 and VLR 134 are used to track the mobile handsets 120 within home or foreign networks, while the RTX 102 is used to track the presence of members of a group within the home or foreign networks and updates the mobile handsets 120 for those members with the network availability of other members of the group.

A Short Message Service Center (SMSC) 138 is accessible via the IP network 124 (or other element) for the storage of text messages (SMS messages). When an SMS message is sent to an MS 120, the message is first stored in the SMSC 138 until the recipient MS 120 is available (e.g., a store-and-forward option).

2.3 Real Time Exchange

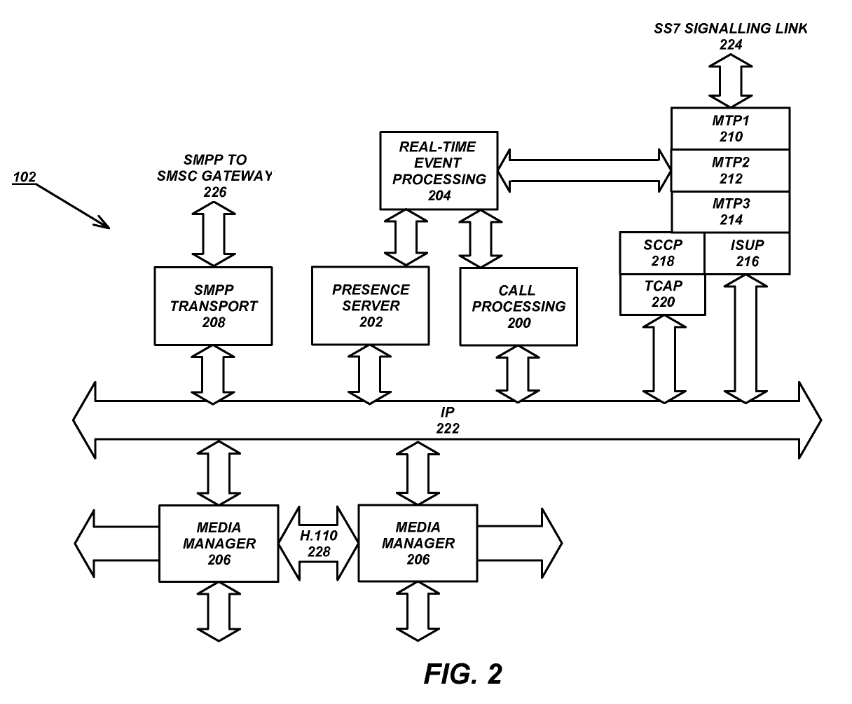

FIG. 2 illustrates a proposed architecture for the RTX 102 according to the preferred embodiment of the present invention.

The architecture includes a Call Processing system 200, Presence Server 202, Real-Time Event Processing system 204, one or more Media Managers 206, and an SMPP (Short Message Peer-to-Peer) Transport 208, as well as modules for various SS7 protocols, such as MTP-1 (Message Transfer Part Level 1) 210, MTP-2 (Message Transfer Part Level 2) 212, MTP-3 (Message Transfer Part Level 3) 214, ISUP (Integrated Services Digital Network User Part) 216, SCCP (Signaling Connection Control Part) 218, and TCAP (Transactions Capabilities Application Part) 220 protocols.

The Call Processing system 200, Presence Server 202, Media Managers 204, SMPP Transport 206, and other modules communicate across an IP network 222. The Real-Time Event Processing system 204 communicates directly with the Call Processing system 200, Presence Server 202, and the modules for various SS7 protocols. The modules for various SS7 protocols communicate with other entities via a SS7 Signaling Link 224. The SMPP Transport 206 communicates with a SMSC (Short Message Service Center) gateway using the SMPP protocol 226. The Media Managers 204 communicate among themselves using the H.110 protocol 228 (or some other protocol, such TCP/IP).

The operation of these various components are described in more detail below, as well as in the co-pending and commonly-assigned patent applications cross-referenced above and incorporated by reference herein.

The originating MS 120 signals the RTX 102 via the wireless network 100, e.g., by transmitting one or more configured DTMF (Dual Tone Multi Frequency) digits to the RTX 102. The Media Manager systems 206 receive the DTMF digits and pass the DTMF digits to the Call Processing system 200. The Call Processing (CP) system 200 determines whether the originating MS 120 has subscribed to the AGS service before originating the AGS call. Upon confirmation, the Call Processing system 200 initiates a new AGS call. The Call Processing system 200 interacts with the Presence Server 202 and Real-Time Event Processing system 204 to cause the wireless network 100 to perform call setup with the terminating MS's 120 for the AGS call, and thereafter to manage the AGS call.

During the AGS call, the Call Processing system 200 interacts with the Media Manager systems 206 to maintain the H.110 channels 227 and assign any additional H.110 channels 228 required for the AGS call, which may span across multiple Media Manager systems 206. During the AGS call, the Media Manager systems 206 of the RTX 102 are used to mix audio streams between the originating MS 120 and the terminating MS 120, and then deliver these mixed audio streams to the originating MS 120 and the terminating MS 120. The H.110 channels 228 are used for passing mixed and unmixed audio streams voice between the Media Manager systems 200 as required.

2.4 Mobile Station Components

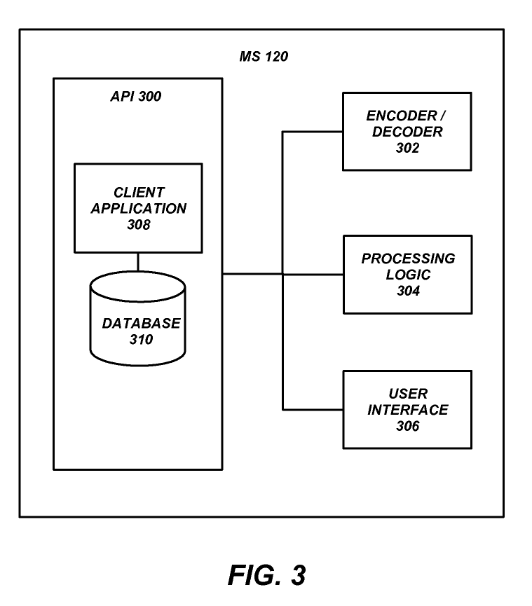

FIG. 3 illustrates the high-level functional components and their interfaces in the MS 120 according to a preferred embodiment of the present invention. In one embodiment, the software architecture used in the MS 120 is based on an Open OS implementation and is available under multiple operating systems, including JAVA, WINDOWS MOBILE, SYMBIAN and BREW.

Preferably, the software architecture used in the MS 120 provides an application programming interface (API) 300 that supports the logic and data required within the MS 120 for providing cellular service, including the functions necessary for the making an AGS call generally, and for providing the Connected Portfolio Services specifically.

The high-level functional components of the MS 120 include an encoder/decoder 302, processing logic 304 and user interface 306. A client application 308 is provided on the SIM 300 that supports AGS functionality for the MS 120. In addition, the SIM 300 stores a database 310, which includes an address book, AGS contacts and/or group information.

At power-on, the MS 120 loads the client application 308 necessary to support the AGS services. This functionality provided includes the “look and feel” of the menu displays on the MS 120, as well as user interaction with the menu displays.

During operation, the encoder/decoder 302 decodes and encodes messages, and populates specific data structures in the MS 120. The encoder/decoder 302 checks the validity of the incoming messages by verifying mandatory parameters for each of the incoming messages. A message will not be processed further if the encoder/decoder 302 fails to decode the message.

The processing logic 304 handles all the AGS related functionalities. The processing logic 304 implementation is device-specific and vendor-specific, and it interacts with the other components, including the encoder/decoder 302, user interface 306, client application 308 and database 310.

The processing logic 304 provides an auto-answer mechanism for AGS calls. Specifically, when a call is received, the processing logic 304 automatically answers the call. The processing logic 304 makes use of call notification for incoming call detection and, based on various parameters received within the call notification, determines whether the call is an AGS call. If the call is an AGS call, then the processing logic 304 uses “AT” commands to answer the AGS call and turn on the speaker of the MS 120. (All of this takes place within a certain time period.) On the other hand, if the call is not an AGS call, then normal call processing is performed by the MS 120.

The processing logic 304 also provides “floor control” using DTMF tone control. In P2T calls, which are half-duplex, a determination of who may talk is based on who has the “floor.” Using the processing logic 304 provided in the MS 120, appropriate DTMF tones are sent to the RTX 102 in accordance with specific key sequences (i.e., pressing and/or releasing a P2T key) that indicate whether the “floor” has been requested and/or released by the user.

In addition, the processing logic 304 provides SMS destination control based on the type of subscriber. At the time of subscriber data provisioning, if it is determined that the MS 120 will use AGS based logic, then appropriate logic is invoked in the RTX 102 to send presence messages over SMS to the MS 120. Similarly, the MS 120 is configured at the time of provisioning to receive/accept such SMS and respond to the RTX 102 appropriately.

Finally, the processing logic 304 also enables subscribers to track the presence of fellow members of the group in the network 100 on their MS 120, and provides a mechanism and API to carry-out contacts and group management operations on the MS 120, such as add member, delete member, etc.

Since most of the presence information is stored in the database 310, the database 310 is tightly integrated with the processing logic 304. The database 310 stores groups, contacts, presence and availability related information. The database 310 information essentially contains group and member information along with presence information associated with each group and member. Apart from group and member information, the database 310 also stores subscriber information, such as privileges, presence information, etc. The other components of the MS 120 may interact with the database 310 to retrieve/update the group, members and presence information for various operations. The database 310 also has pointers to the native address book on the MS 120, to provide seamless “alias” naming for contacts used with cellular calls, as well as AGS services.

The user interface 306 provides a mechanism for the user to view and manage groups, group members, contacts, presence and availability. The user interface 306 also makes it possible to invoke the AGS services from the group/contact list screens, as described in more detail below.

2.5 Connected Portfolio Services

The RTX 102 and MS 120 work together to provide the functionality of the Connected Portfolio Services for the wireless communications network 100. The specifics of this functionality are described in more detail in the following sections.

2.6 Acronyms and Messaging

In the following sections, a number of call flows are described and illustrated. These call flows use a number of different acronyms, including the following:

IAM: Initial Address Message,

ACM: Address Complete Message,

ANM: Answer Message,

REL: Release Message,

RCL: Release Complete Message,

SMS: Short Message Service,

MO_SM: Mobile originating Short Message,

FSM: Forward Short Message,

Data_SM: Data Short Message received by SMSC,

Deliver_SM: Deliver Short Message from SMSC,

MO_SM: Mobile originating Short Message,

IN: Intelligent Network,

IDP: Initial Detection Point,

Continue: Continue the call processing,

Connect: Connect to the new terminating number provided in the message,

IDP_SM: Initial Detection Point for SMS,

MDN: Mobile Directory Number, and

SCA: Service Centre Address in SMS network.

The voice call related messages include: Setup, Originating, Terminating, IAM, Alerting, ACM, Connect, ANM, Disconnect, REL, release, Disconnect Ack, and RCL release complete.

The SMS related message include: MO-SM, FSM (a.k.a. Fwd_SM), Data_SM, Deliver_SM, and MT_SM.

The IN messages include: IDP, Connect, Continue, release, and IDP_SM.

In general, the parameters in the voice call originating and terminating messages are calling party number (e.g. A) and called party number (e.g. B). The B party in the originating message could be a number dedicated to the RTX 102 or the MS 120. On the other hand, the A party in the terminating message could be a number dedicated to the RTX 102 or the MS 120.

The following sections describe the steps for the call flow as well as each message in the call flow.

### 3 Scheduled Conference

The Scheduled Conference service allows a moderator to schedule a conference in advance. Establishing a scheduled conference can be done by connecting to the RTX 102 through the handset 120 or via Internet access. The originator can specify how to set up the type of participant connection (Dial-In or Dial-Out) and whether a moderator (e.g., the originator) is required on the call or not.

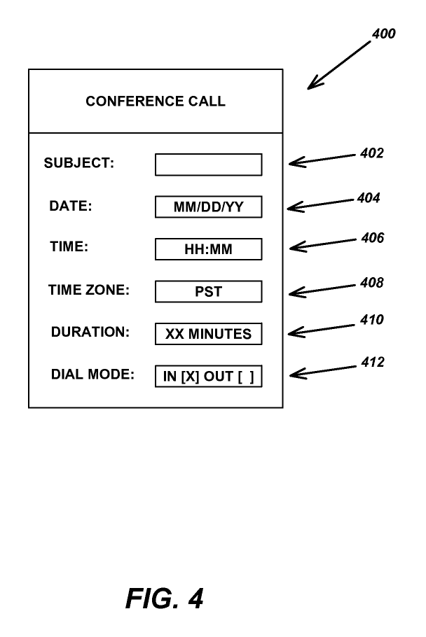

FIG. 4 illustrates the user interface 400 for the conference scheduler as displayed on the handset 120. The user can specify a subject 402, date 404, time 406, time zone 408, duration 410, as well as dial mode options 412, including either Dial-In or Dial-Out modes of operation.

The RTX 102 notifies each participant and originator with the conference details using SMS. For Dial-Out conferences, the RTX 102 dials each participant at the scheduled time. For Dial-In conferences, each participant simply presses the Send key on their handset 120 after high-lighting the bridge number within the conference details SMS.

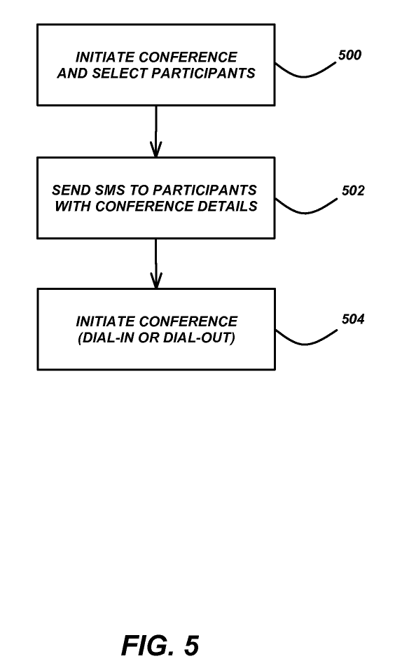

FIG. 5 is a flowchart that illustrates the steps performed in a Scheduled Conference.

Block 500 represents the originator selecting a “New Conference” option on the handset 120 and providing the conference details via the user interface shown in FIG. 4. The originator then selects the conference participants from the address book, and presses the Send key on the handset 120 to complete the scheduling of the conference, which sends an SMS to the RTX 102.

Block 502 represents the RTX 102 sending a conference details SMS to the conference participants.

Block 504 represents the initiation of the conference, at the conference start time.

In Dial-In mode, the participant selects the conference details SMS on the handset 120 and then selects the Send key on the handset 120 to dial into the conference. The conference participants may also dial in from a landline using a global number and access code.

In Dial-Out mode, the RTX 102 will dial out to all the participants as well as the originator.

3.1 End User Features

The main features of the Scheduled Conference include the following:
Dial-In or Dial-Out Conference Type,
Start Without Me option (Yes/No),
Continue Without Me option (Yes/No),
Duration of Conference, and
My Conferences Tab (view of conferences originated and/or participated in).

3.2 Mid Call Add/Drop

This feature provides the user with the ability to add or drop participants to an active conference call. The user can select some specified number of participants to add to or drop from a conference call. The Mid Call Add/Drop feature can be accessed by the user under an Options menu on the handset 120.

3.3 Rejoin a Conference Call

This feature allows for the originator or any participants of a conference call to rejoin an active conference call, if they have dropped at any time. The RTX 102 sends an SMS to the originator and all participants of the conference call with the bridge information. The end user can simply press the Send key on the handset 120 while displaying the SMS to rejoin the conference call. To rejoin a clientless conference, the participants can dial a global conference number and enter an access code at any time. (An SMS is not sent to clientless conference participants.)

3.4 Call Flows

This section explains the call flows for Scheduled Conference in CDMA and GSM networks.

3.4.1 Call Flows for CDMA Network

3.4.1.1 Conference Call via Dial-Out

This call flow depicts how the participants of a given conference call are established (i.e. terminated) by the RTX 102. This type of call is an Instant Conference (IC) and Scheduled Conference (SC) in Dial-Out mode. For SC, steps 1 through 6 are replaced by an internal timer, which is set by the SC originator during the SC creation stage.

In order to distinguish prepaid from postpaid for the originator, a prefix is required in the called party number of IAM (initial address message), sent by the RTX 102. The prefix allows the GMSC 104 (Gateway MSC, i.e., the MSC 104 connected to the RTX 102) to determine whether a PPS (PrePaid System) involvement is required or not. The following call flow represents the originator (MS1) as a prepaid subscriber, and therefore an RTX 102 prefix (e.g. 111) to the called party number of the IAM is sent. The GMSC, based on the prefix, sends an IDP (initial detection point) to the PPS. The details of IN message exchanges are omitted.

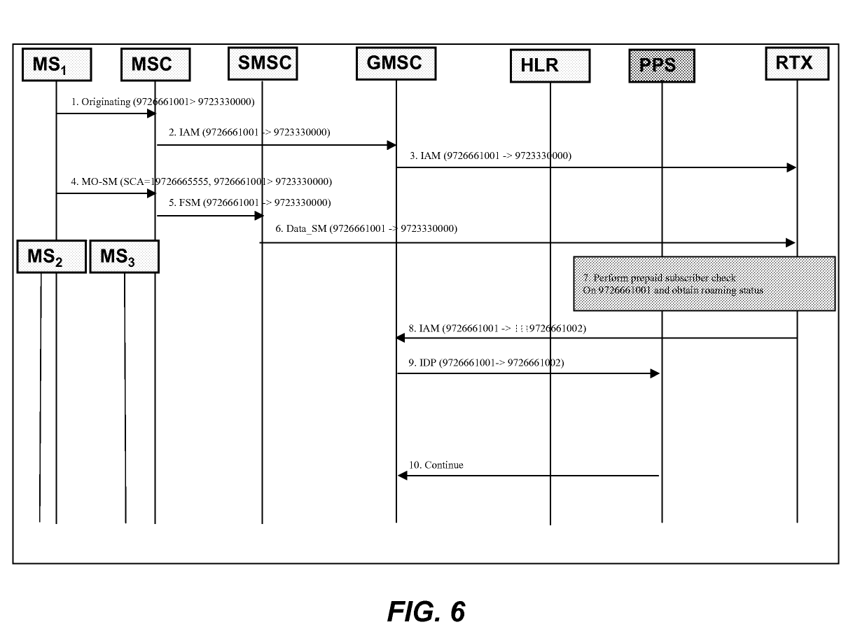

FIG. 6 is a call flow diagram that illustrates the steps performed in a Conference Call via Dial-Out in a CDMA network. The steps include the following:

1. MS1 makes a call to the RTX (wherein 9726661001 is the MDN of MS1 and 972333000 is a well known MDN assigned to the RTX so that a voice call can be routed/terminated to the RTX 102).

2. Because the called party number is the well-known number of the RTX, the MSC routes the call to the RTX via the GMSC by sending an IAM.

3. Upon receiving the IAM from the RTX, the GMSC sends an IAM to the RTX.

4. An SMS containing a participant list is sent by MS1 to the MSC as an MO-SM (Mobile Originated Short Message) containing a SCA (Service Center Address) set to SMSC (wherein 197266655555 is the address of the SMSC).

5. Because the SCA is set to SMSC, the MSC forwards the SMS to the SMSC via FSM (Forward Short Message).

6. The SMSC delivers the SMS (Data_SM or Data Short Message) to the RTX.

7. The RTX 102 performs a prepaid determination and roaming check.

8. Because the originator is a prepaid subscriber, the RTX 102 prefixes the configurable digits “111” to the called party number of the IAM sent to the GMSC (wherein 9726661002 is the MDN of MS2).

9. Based on the prefix digits in the called party number of the IAM received from the RTX, the GMSC sends an IDP to the PPS.

10. The PPS returns “Continue” to the GMSC.

3.4.1.2 Conference Call Via Dial-In

This call flow depicts how each participant initiates the call (i.e. “jumps on the bridge”). This type of call is a Reservationless Conference (RC) and Scheduled Conference (SC) in Dial-In mode.

Since each participant makes his/her own call, the charge is done in the originating MSC, regarding whether the participant is a postpaid or prepaid. The following call flow skips the PPS involvement message exchange because it beyond the scope of this document.

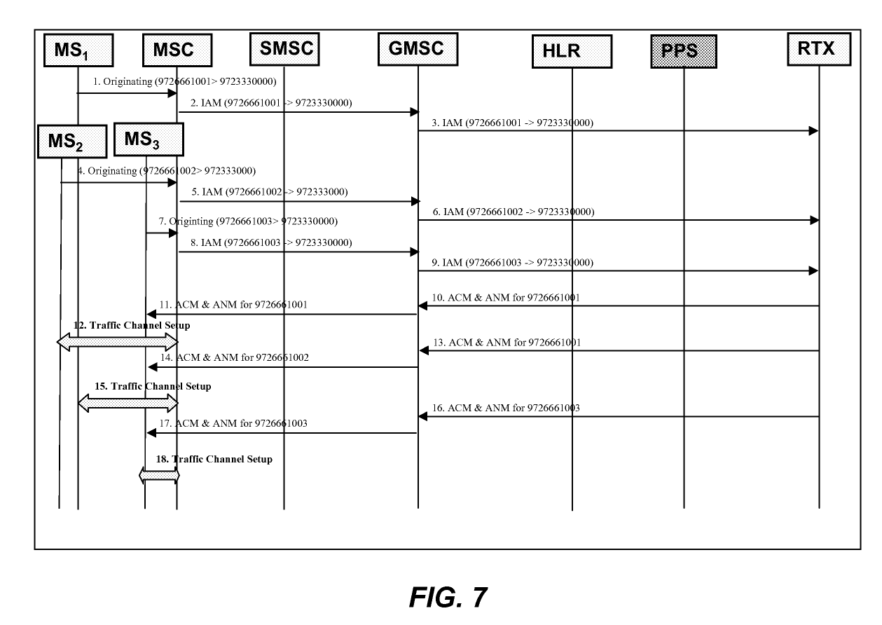

FIG. 7 is a call flow diagram that illustrates the steps performed in a Conference Call via Dial-In in a CDMA network. The steps include the following:

1. MS1 makes a call to the RTX.

2. Because the called party number is the well-known number of the RTX, the MSC routes the call to the RTX via the GMSC by sending an IAM to the GMSC.

3. Upon receiving the IAM from the MSC, the GMSC sends an IAM to the RTX.

4. MS2 makes a call to the RTX.

5. Because the called party number is the well-known number of the RTX, the MSC routes the call to the RTX via the GMSC, by sending an IAM to the GMSC.

6. Upon receiving the IAM from the MSC, the GMSC sends an IAM to the RTX.

7. MS3 makes a call to the RTX (wherein 9726661003 is the MDN of MS3).

8. Because the called party number is the well-known number of the RTX, the MSC routes the call to the RTX via the GMSC, by sending an IAM to the GMSC.

9. Upon receiving the IAM from the MSC, the GMSC sends an IAM to the RTX.

10. The RTX connects the call by responding with an ACM (Address Complete Message) and ANM (Answer Message) to the GMSC.

11. The GMSC forwards the ACM and ANM back to the MSC.

12. The MSC establishes a traffic channel to MS1.

13. The RTX connects the call by responding with an ACM and ANM to the GMSC.

14. The GMSC forwards the ACM and ANM back to the MSC.

15. The MSC establishes a traffic channel to MS2.

16. The RTX connects the call by responding with an ACM and ANM to the GMSC.

17. The GMSC forwards the ACM and ANM to the MSC.

18. The MSC establishes a traffic channel to MS3.

3.4.1.3 Conference Call Setup/Modification/Cancellation Via Handset

This call flow depicts how a Scheduled Conference is created. The same call flow also represents when user performs a modification or cancellation via the handset. If the request fails due to any condition, steps 7 to 12 are not sent.

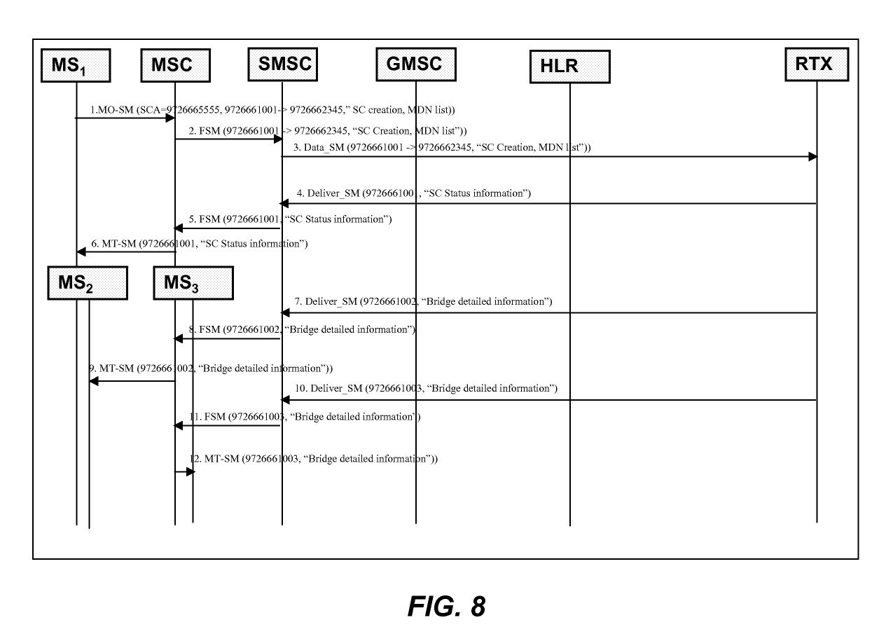

FIG. 8 is a call flow diagram that illustrates the steps performed in a Conference Call Creation. The steps include the following:

1. MS1 sends an SMS to setup a Scheduled Conference (wherein 9726662345 is a well-known SMS routable number dedicated to the RTX for group creation, and is used by user to send service group creation information to RTX via SMS; the operator is “SC creation” and the MDN list identifies the conference participants).

2. The MSC routes the MO-SM to the SMSC by sending an FSM.

3. Upon receiving the FSM from the MSC, the SMSC sends a Data_SM to the RTX.

4. The RTX creates a Schedule Conference event and responds with a confirmation by sending Deliver-SM (Deliver Short Message) to the SMSC. If the Scheduled Conference creation fails for any reason, a negative SMS is sent to the SC requester.

5. Upon receiving the Deliver-SM from the RTX, the SMSC sends an FSM to the MSC where MS1 is registered.

6. The MSC delivers the MT_SM to MS1.

(The following steps happen only for successful scenario.)

7. The RTX sends a Deliver-SM to participant MS2 via the SMSC.

8. Upon receiving the Deliver-SM from the RTX, the SMSC sends an FSM to the MSC where MS2 is registered.

9. The MSC delivers the MT_SM to MS2.

10. The RTX sends a Deliver-SM to participant MS3 via the SMSC.

11. Upon receiving the Deliver-SM from the RTX, the SMSC sends an FSM to the MSC where MS3 is registered.

12. The MSC delivers the MT_SM to MS3.

3.4.2 Call Flows for GSM Network

3.4.2.1 Conference Call Via Dial-Out

This call flow depicts how the participants of a given conference call are established (i.e. terminated) by the RTX. This type of call is an Instant Conference (IC) and Scheduled Conference (SC) in Dial-Out mode. For SC, Steps 1 through 6 are replaced by an internal timer, which is set by the SC originator during the SC creation stage.

In order to distinguish prepaid from postpaid of the service initiator, a prefix is required in the called party number of the IAM sent by the RTX. The prefix allows the GMSC to determine whether PPS involvement is required or not. The following call flow represents the originator (MS1) as a prepaid subscriber, therefore the RTX prefix (e.g. 111) is sent to the called party number of the IAM. The GMSC, based on the prefix, sends an IDP to PPS. The details of IN message exchanges are omitted.

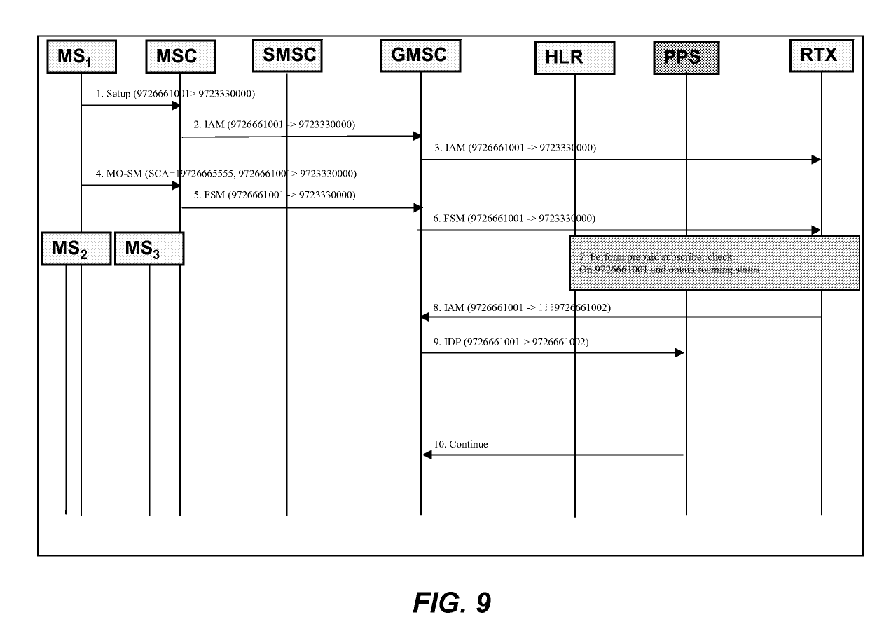

FIG. 9 is a call flow diagram that illustrates the steps performed in a Conference Call via Dial-Out in a GSM network. The steps include the following:

1. MS1 makes a call to the RTX.

2. Because the called party number is a well-known number for the RTX, the MSC routes the call to the RTX via the GMSC by sending an IAM to the GMSC.

3. Upon receiving the IAM from the MSC, the GMSC sends an IAM to the RTX.

4. An SMS containing a participant list is sent by MS1 to the MSC.

5. Because the Service Center Address (SCA) is set to the RTX in an SMSC bypass configuration, the MSC forwards the SMS to the RTX via FSM through the GMSC.

6. The GMSC forwards the FSM to the RTX.

7. The RTX performs a prepaid determination and roaming check.

8. Because the originator is a prepaid subscriber, the RTX prefixes the configurable digits to the called party number of the IAM sent to the GMSC.

9. Based on the prefix digits in the called party number of the received IAM, the GMSC sends an IDP to the PPS.

10. The PPS returns a “Continue” to the GMSC.

3.4.2.2 Conference Call Via Dial-In

This call flow depicts how each participant initiates lumps on the bridge) the call. This type of call is a Reservationless Conference (RC) and Scheduled Conference (SC) in Dial-In mode.

Since each participant makes his/her own call, a charge is performed in the originating MSC regarding whether the participant is a postpaid or prepaid. The following call flow skips the PPS involvement message exchange because it is beyond the scope of this document.

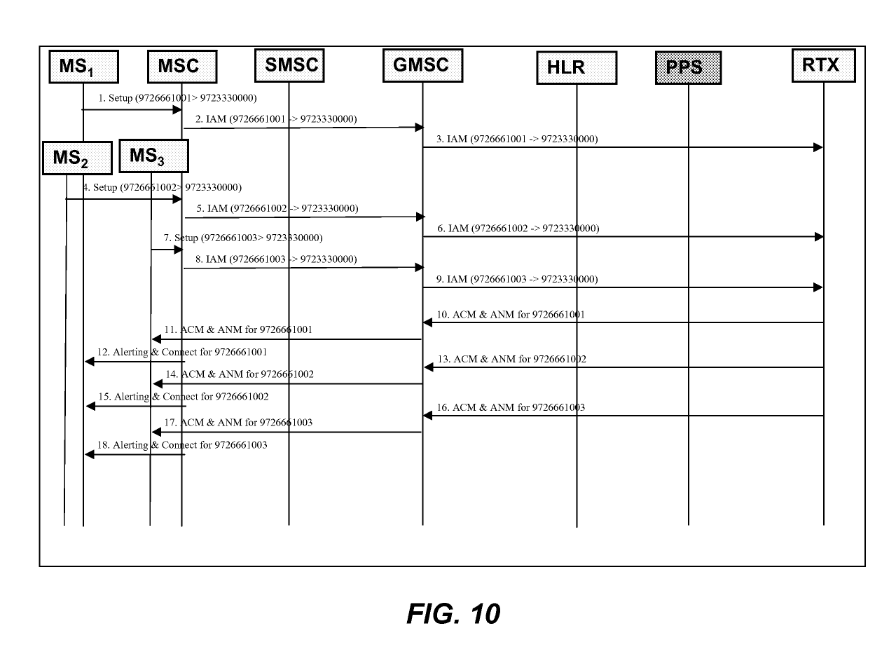

FIG. 10 is a call flow diagram that illustrates the steps performed in a Conference Call via Dial-In in a GSM network. The steps include the following:

1. MS1 makes a call to the RTX.

2. Because the called party number is a well-known number of the RTX, the MSC routes the call to the RTX via the GMSC by sending an IAM to the GMSC.

3. Upon receiving the IAM from the MSC, the GMSC sends an IAM to the RTX.

4. MS2 makes a call to the RTX.

5. Because the called party number is a well-known number of the RTX, the MSC routes the call to the RTX via the GMSC by sending an IAM to the GMSC.

6. Upon receiving the IAM from the MSC, the GMSC sends an IAM to the RTX.

7. MS3 makes a call to the RTX.

8. Because the called party number is a well-known number of the RTX, the MSC routes the call to the RTX via the GMSC by sending an IAM to the GMSC.

9. Upon receiving the IAM from the MSC, the GMSC sends an IAM to the RTX.

10. The RTX connects the call by responding with an ACM and ANM to the GMSC.

11. The GMSC forwards the ACM and ANM to the MSC.

12. The MSC alerts and connects the call to MS1.

13. The RTX connects the call by responding with an ACM and ANM to the GMSC.

14. The GMSC forwards the ACM and ANM to the MSC.

15. The MSC alerts and connects the call to MS2.

16. The RTX connects the call by responding with an ACM and ANM to the GMSC.

17. The GMSC forwards the ACM and ANM to the MSC.

18. The MSC alerts and connects the call to MS3.

3.4.2.3 Conference Call Setup/Modification/Cancellation Via the Handset

This call flow depicts how a scheduled conference is created. The same call flow also represents when a user performs a modification or cancellation via the handset. If the request fails for any reason, steps 6 to 11 are not performed.

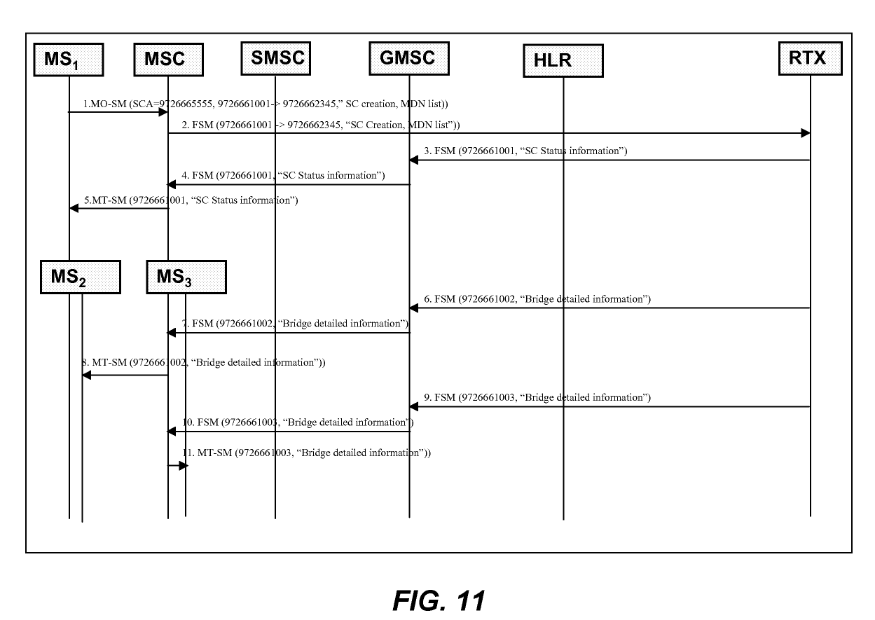

FIG. 11 is a call flow diagram that illustrates the steps performed in a Conference Call Creation. The steps include the following:

1. MS1 sends an MO-SM to setup a Scheduled Conference.

2. Because the SCA is set to the RTX, the MSC routes the MO-SM to the RTX by sending an FSM to the RTX.

3. The RTX creates a Schedule Conference event and responds with a confirmation by sending an FSM to the GMSC. If the Scheduled Conference creation failed for any reason, a negative SMS is sent to the SC requester.

4. Upon receiving the FSM from the RTX, the GMSC forwards the FSM to the MSC where MS1 is registered.

5. The MSC delivers the MT-SM (Mobile Terminated-Short Message) to MS1.

(The following steps are performed only in a successful scenario.)

6. The RTX sends an FSM to participant MS2 via the GMSC.

7. Upon receiving the FSM from the RTX, the GMSC forwards the FSM to the MSC where MS2 is registered.

8. The MSC delivers the MT-SM to MS2.

9. The RTX sends an FSM to participant MS3 via the GMSC.

10. Upon receiving the FSM from the RTX, the GMSC forwards the FSM to the MSC where MS3 is registered.

11. The MSC delivers the MT-SM to MS3.

### 4 Family Connect Group Call

The Family Connect service is an instant conference call service that utilizes the existing operator's existing family plan database and terminates calls to all the family members when a national-wide number is dialed by the user.

The main features of Family Connect are:
One group per user,
Existing family plan databases can be used,
One global national-wide access number (i.e. a dialable number), and
Group management via the Internet.

However, when an operator's network does not provide a family plan database, this service provides a Web interface for the user to create/update/view her/his own family members.

### 5 Buddy Connect Group Call

The Buddy Connect service is instant conference call service, wherein the user creates “buddy connect” groups via the Internet.

The main features of Buddy Connect are:
Multiple groups per user,
Each group contains up to a specified number of members,
Each member can be in multiple groups,
Each group is assigned a unique access number (i.e. a dialable number),
Group management is performed by the creator via the Internet.

### 6 Quick Reach Call

The Quick Reach service allows a user to reach a called party by making call attempts to all possible phones (i.e., Customer Premise Equipment (CPE)) used or owned by the called party. The user creates Quick Reach groups via the Internet.

The main features of Quick Reach are:
Multiple groups per user,
Each group contains up to a specified number of contact numbers,
Each group is assigned a unique access number (i.e. a dialable number),
Group management is performed by the creator via the Internet.

### 7 Reservationless Conference/Clientless Conference

A Reservationless Conference, also known as Clientless Conference, provides a “Meet me on my bridge” capability without a client on the handset 120. Each clientless conference subscriber will have a standing bridge that can be accessed at anytime. The conference owner will create an access code for each conference and provide the access code to the participants. Participants will enter the access code that was created by the conference owner and join the conference once the owner has joined the call.

7.1 Originator User Flows

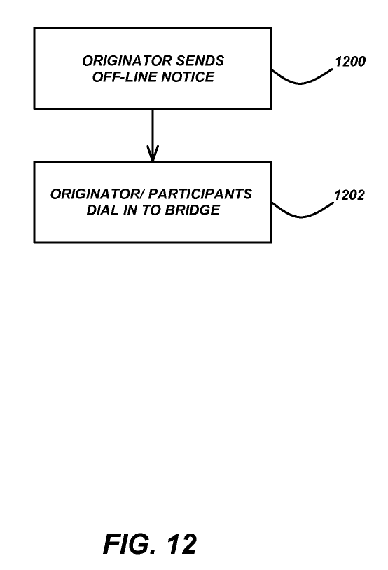

FIG. 12 is a flowchart that illustrates the steps performed in a Reservationless Conference Origination.

Block 1200 represents the originator, using a handset 120 with a client application, sending an off-line conference notice, which includes a call-in number allocated by the RTX 102, a conference ID such as the originator's mobile number, and an access code.

Block 1202 represents the initiation of the conference, at the conference start time. The originator and the participants dial the call-in number, and are prompted by the RTX 102 to enter the conference ID and the access code. The conference participants may dial in from a landline as well as a handset 120. All of the participants can rejoin the conference call at any time using the same steps.

7.2 End User Features

The main features of the Reservationless Conference include the following:
A single conference bridge number to remember,
Mid Call Add using dialed digits,
Mid Call Drop using dialed digits,
A List of Participants sent via SMS to all members in conference,
Support for any Dial-able Number,
Rejoin a conference call, and
Originator creates access code per conference.

7.3 Mid Call Add/Drop

This feature provides the user with the ability to add or drop participants to/from an active Clientless Conference. The originator can enter the full MDN of the participant to add or drop from the keypad of the handset during an active Clientless Conference

### 8 Clientless Command Support

In order to attract more users, the present invention introduces a command interface for users whose handsets cannot support a client application.

The Clientless Command Support service provides subscribers with the ability to create and maintain groups using easy commands and then use the created groups for standard wireless or connected services. Using this functionality, network operators can provide group-based communications for those handsets that cannot support a client application.

Using the well-known number of the RTX 102 (which is published by the operator), any user can: (1) send a text SMS, (2) access a web page, or (3) log onto web site, to create a dynamic group contact list, on the fly, and request a connected service. The steps are:

1. The user creates a contact group via SMS on the handset 120, where the text body of the SMS contains a recipient list, and then forwards the SMS to the RTX 102.

2. The user receives a confirmation SMS back from the RTX 102.

3. If the user replies to the confirmation SMS, then it is a GSMS service.

4. If the user calls back through the confirmation SMS, the RTX 102 will play an announcement so that user can select either IC or VSMS service.

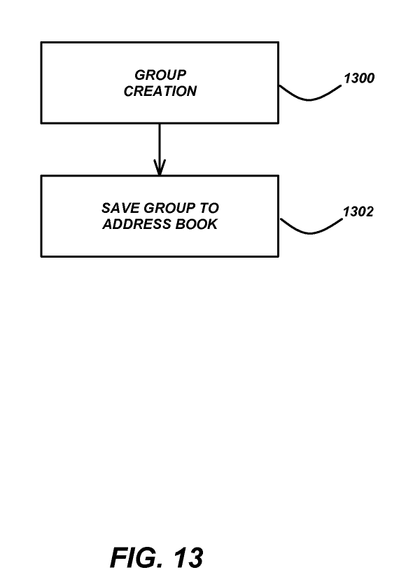

FIG. 13 is a flowchart that illustrates the steps performed in Clientless Group Creation.

Block 1300 represents the originator, using a handset 120 without a client application, creating a group by sending an operator configurable group creation command to the RTX 102. The RTX 102 responds back with a message indicating that the group has been created, identifying the pertinent aspects of the group.

Block 1302 represents the originator saving the group to the address book of the handset 120.

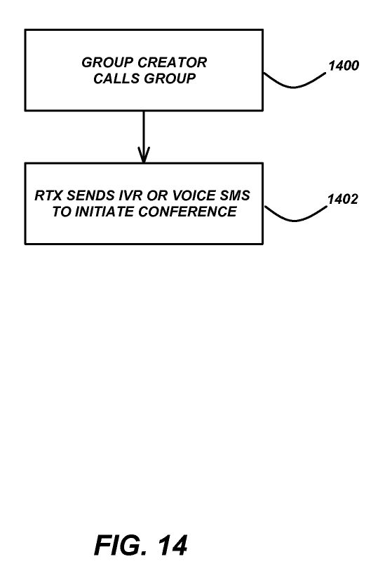

FIG. 14 is a flowchart that illustrates the steps performed in placing a mobile conference call with the clientless group.

Block 1400 represents the originator, using a handset 120 without a client application, selecting the group and pressing the Send key on the handset 120, which results in a group initiation voice call being sent to the RTX 102.

Block 1402 represents the RTX 102 responding to the originator using an Interactive Voice Response (IVR) system, wherein the originator selects either a conference call or a Voice SMS. The RTX 102 then either terminates the conference call to all members to form a conference call, or records the originator's voice message and sends an SMS notification to all members of the group.

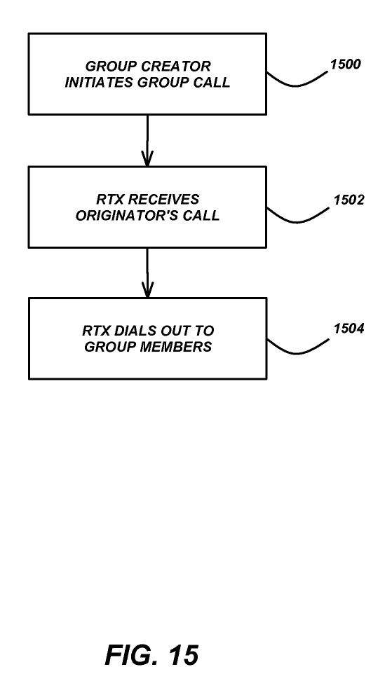

FIG. 15 is a flowchart that illustrates the steps performed in placing a mobile conference call with a client application.

Block 1500 represents the originator, using a handset 120 with a client application, selecting the group and pressing the Send key on the handset 120, which results in a group call initiation and SMS being sent to the RTX 102.

Block 1502 represents the RTX 102 receiving the originator's call, and responding by setting up the group call.

Block 1504 represents the RTX 102 dialing out to the group members, on either the mobile or wireline networks, at the same time to establish the group call. The group members will see the originator's ID, and the RTX 102 uses the IVR system to announce that a conference call has been initiated, and that the group members can join the call by pressing the # key.

8.1 Group Creation Via IVR

Group Creation for Instant or Scheduled Conferencing can also be achieved through the use of an Interactive Voice Response (IVR) system. In this embodiment, a user dials a predetermined number to reach the IVR system. The IVR system prompts the user to select or enter the type of conference (Instant or Scheduled), date, time, duration (if applicable), as well as the numbers of the conference participants. The user inputs the information either using the telephone keypad (DTMF) or voice, based on an operator's network capabilities to decode the input information.

The IVR system interfaces to the RTX 102 and sends an SMS message with the conference details to the RTX 102, which then creates the group.

8.2 End User Features

The main features of the Clientless Command Support include the following:
Group Size,
Standard SMS used to create Client Groups,
Create, Modify, and Delete Groups using SMS,
Store group originating number received in group creation confirmation SMS in the address book of the handset 120,
Originate a Connected Application from the Clientless Group number assigned.

### 9 Group SMS (GSMS) with Reply All

The Group SMS (GSMS) application allows users to compose and send a single SMS message simultaneously to a list of one or more participants. The GSMS message is sent to the RTX 102, which then sends a standard SMS message to all recipients. The recipients may reply to the originator of the GSMS message or to the entire recipient list, based upon the feature configuration setting in the RTX 102.

9.1 Originator User Flow

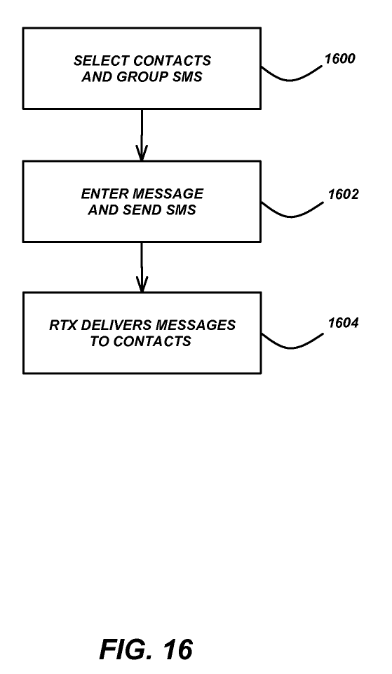

FIG. 16 is a flowchart that illustrates the steps performed in Group SMS with Reply All.

Block 1600 represents the GSMS creator, using a handset 120, selecting the contacts, and then selecting a “Group SMS” option.

Block 1602 represents the GSMS creator, using a handset 120, typing in the message, and then selecting a “Send SMS” option.

Block 1604 represents the RTX 102 receiving the GSMS message, and then delivering the GSMS message to the selected contacts in their inbox.

9.2 End User Features

The Group SMS application provides the following end user features:
1-to-1 or 1-to-many text messaging,
Recipients can reply back to the originator or the entire recipient list,
Messages are received in their SMS Inbox,
Group messages can be sent to as many as 30 members,
Message lengths up to:
   160 characters for GSM networks, or
   158 characters for CDMA networks.

9.3 Call Flows

This section explains the Non-IN Trigger call flows for Group SMS in the CDMA and GSM networks.

9.3.1 Call Flows for CDMA Network

9.3.1.1 Postpaid GSMS

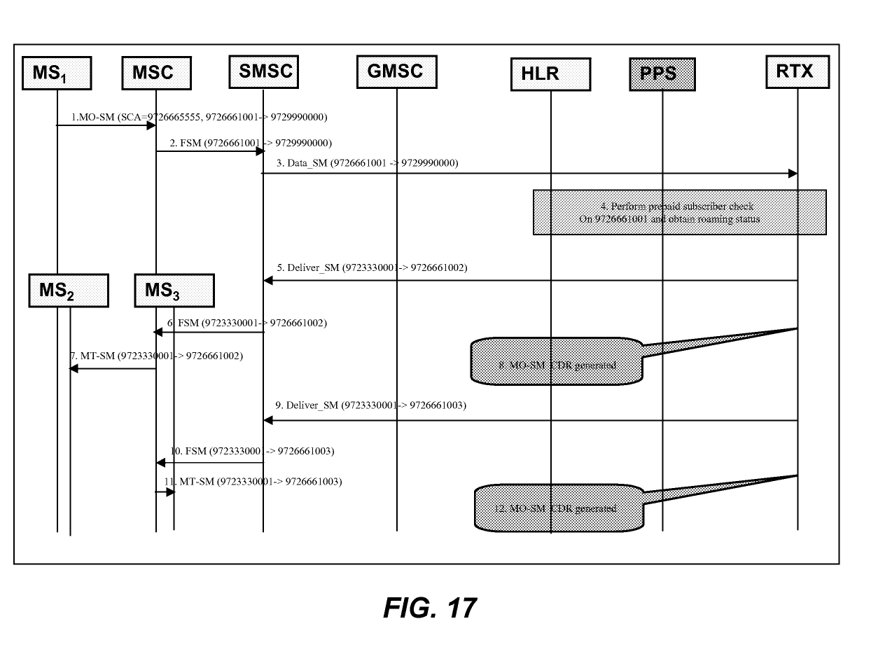

FIG. 17 is a call flow diagram that depicts the GSMS service initiated by a postpaid user in a CDMA network. The steps include the following:

1. MS1 sends a GSMS message via SMS.

2. The MSC routes the SMS to the SMSC via FSM.

3. Based on the destination number, the SMSC delivers the SMS to the RTX.

4. The RTX performs a prepaid and roaming check, and identifies the GSMS originator as a postpaid subscriber.

5. The RTX obtains the recipient list and sends an MT-SM to MS2 via the SMSC.

6. The SMSC locates the MS2, and forwards the MT-SM via FSM to the MSC where MS2 is registered.

7. The MSC delivers the MT-SM to MS2.

8. The RTX generates an MO-SM CDR (call detail record).

9. The RTX obtains the recipient list and sends an MT-SM to MS3 via the SMSC.

10. The SMSC locates the MS3 and forwards the MT-SM via FSM to the MSC where MS3 is registered.

11. The MSC delivers the MT-SM to MS3.

12. The RTX generates an MO-SM CDR.

9.3.1.2 Prepaid GSMS

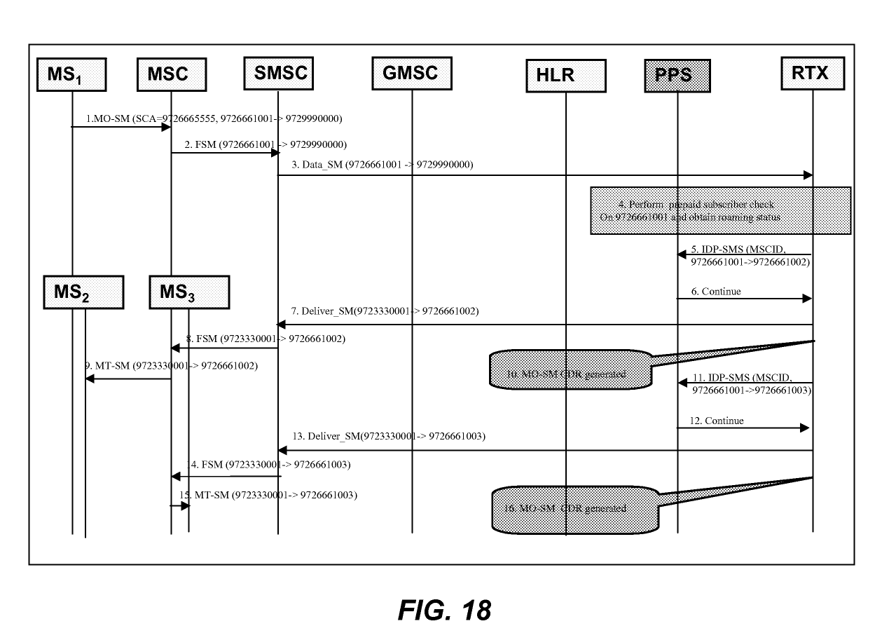

FIG. 18 is a call flow diagram that depicts the GSMS service initiated by a prepaid user in a CDMA network. The steps include the following:

1. MS1 sends a GSMS message via SMS (wherein 972999000 is a SMS routable number dedicated to the RTX for GSMS service).

2. The MSC routes the SMS to the SMSC via FSM.

3. Based on the destination number, the SMSC delivers the SMS to the RTX.

4. The RTX performs a prepaid and roaming check, and identifies the GSMS originator as a prepaid subscriber.

5. For a prepaid subscriber, the RTX reports a premium SMS to PPS via IDP for real-time deduction for delivering the GSMS message to MS2.

6. The MS1 has sufficient funds, and therefore PPS returns a “Continue” back to the RTX.

7. The RTX obtains the recipient list and sends an MT-SM to MS2 via the SMSC (wherein 97333xxxx numbers are used by the RTX to perform GSMS chatting, xxxx=0000-9999, and xxxx are numbers allocated from a limited pool of routable numbers as described in more detail below).

8. The SMSC locates the MS2, and forwards the MT-SM via FSM to the MSC where MS2 is registered.

9. The MSC delivers the MT-SM to MS2.

10. The RTX generates an MO-SM CDR.

11. Again, for a prepaid subscriber, the RTX reports a premium SMS to PPS via IDP for a real-time deduction for delivering the GSMS message to MS3.

12. MS1 has sufficient funds, and therefore PPS returns a “Continue” back to the RTX.

13. The RTX obtains the recipient list, and sends an MT-SM to MS3 via the SMSC.

14. The SMSC locates MS3, and forwards the MT-SM via FSM to the MSC where MS3 is registered.

15. The MSC delivers the MT-SM to MS3.

16. The RTX generates MO-SM CDR.

9.3.2 Call Flows for GSM Network

9.3.2.1 Postpaid GSMS

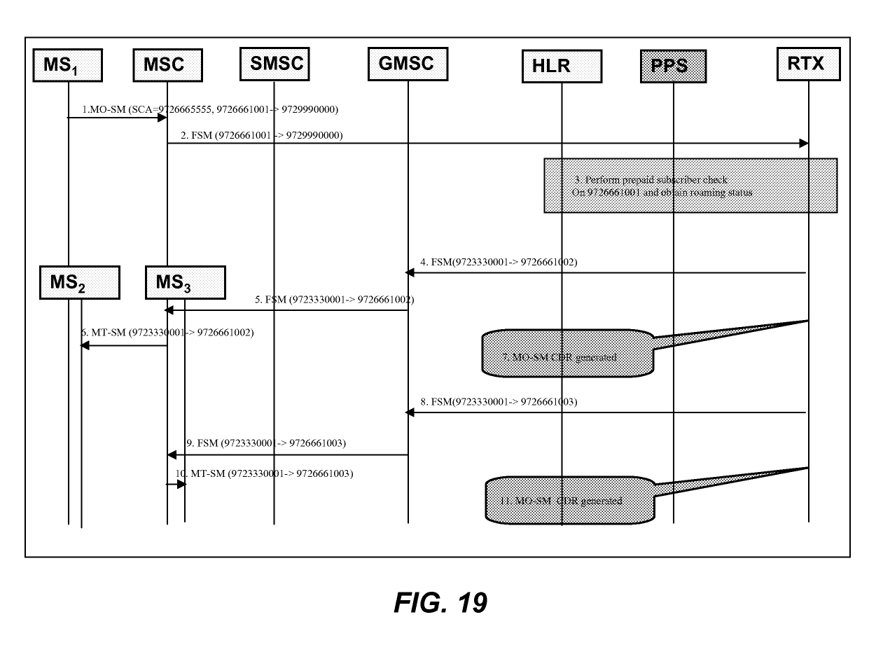

FIG. 19 is a call flow diagram that depicts the GSMS service initiated by a postpaid user in a GSM network. The steps include the following:

1. MS1 sends a GSMS message via SMS.

2. Based on the SCA (i.e. SMSC bypass configuration), the MSC routes the SMS to the RTX via FSM.

3. The RTX performs a prepaid and roaming check, and identifies the GSMS originator as a postpaid subscriber.

4. The RTX obtains the recipient list, and sends an MT-SM to MS2 via the GMSC.

5. The GMSC forwards the FSM to the MSC where MS2 is registered.

6. The MSC delivers the MT-SM to MS2.

7. The RTX generates an MO-SM CDR.

8. The RTX obtains the recipient list, and sends an MT-SM to MS3 via the GMSC.

9. The GMSC forwards the FSM to the MSC where MS3 is registered.

10. The MSC delivers the MT-SM to MS3.

11. The RTX generates an MO-SM CDR.

9.3.2.2 Prepaid GSMS

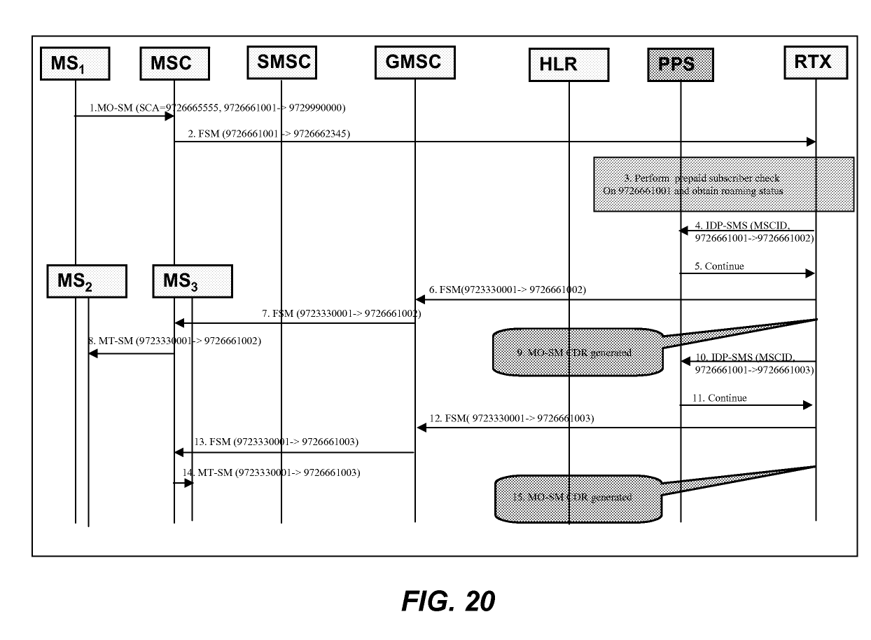

FIG. 20 is a call flow diagram that depicts the GSMS service initiated by a prepaid user in a GSM network. The steps include the following:

1. MS1 sends a GSMS message via SMS.

2. Based on the SCA (i.e. SMSC bypass configuration), the MSC routes the SMS to the RTX via FSM.

3. The RTX performs a prepaid and roaming check, and identifies the GSMS originator as a prepaid subscriber.

4. For a prepaid subscriber, the RTX reports a premium SMS to PPS via IDP for a real-time deduction for delivering the GSMS to MS2.

5. MS1 has sufficient funds, and therefore PPS returns a “Continue” back to the RTX.

6. The RTX obtains the recipient list and sends an MT-SM to MS2 via the GMSC.

7. The GMSC forwards the FSM to the MSC where MS2 is registered.

8. The MSC delivers the MT-SM to MS2.

9. The RTX generates an MO-SM CDR.

10. Again, for a prepaid subscriber, the RTX reports a premium SMS to PPS via IDP for a real-time deduction for delivering the GSMS message to MS3.

11. MS1 has sufficient funds, and therefore PPS returns a “Continue” back to the RTX.

12. The RTX obtains the recipient list, and sends an MT-SM to MS3 via the GMSC.

13. The SMSC forwards the FSM to the MSC where MS3 is registered.

14. The MSC delivers the MT-SM to MS3.

15. The RTX generates an MO-SM CDR.

### 10 Voice SMS (VSMS) with Reply All

Voice SMS (VSMS) is an instant voice messaging application that allows the subscriber to quickly and easily leave voice messages to any mobile device, landline or group without waiting for or ringing the recipient's phone. Voice SMS does not require integration with the carrier's voice mail system and allows for voice messages to recipients outside of the carrier's network.

The subscriber leaves a voice message for individuals or groups who are notified with an SMS message, or any landline number to which the RTX 102 will dial-out if the Dial-Out option is enabled. The recipients can then call back to an Interactive Voice Mail (IVR) system from the SMS message, and retrieve and reply to the voice message by leaving their own voice message.

The Voice SMS solution provides two options to initiate VSMS calls:
Clientless option: * dialing for 1-to-1 and assigned group number for 1-to-many, and
Client option: assigned group number for 1-to-1 and 1-to-many.

The recipient is notified via SMS on their mobile handsets 120, and can use the SMS call back feature to listen to the voice message on the IVR system, reply to the sender, or reply to the sender and all original recipients.

Voice SMS calls may be set up for:
Individual contacts,
Groups,
A quick group from contact list of ad-hoc contacts, and
A sub group members list within group (group within a preset group).

10.1 Voice SMS User Experience—Clientless Option

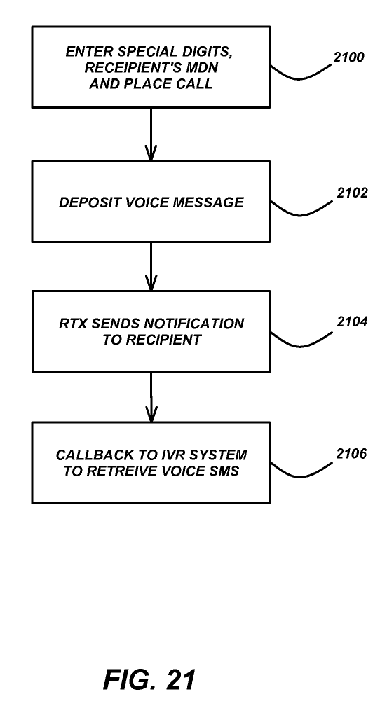

FIG. 21 is a flowchart that illustrates the steps performed when a user invokes a (star) dialing option to send a Voice SMS to a single recipient, i.e., a mobile MDN. Note that, for the “*” dialing option, the originator does not need to be provisioned in the RTX 102.

Block 2100 represents the Voice SMS creator, using a handset 120, entering special digits (e.g. “*123”) followed by the recipient's MDN, and then selecting the Send key on the handset 120. The special digits in the call setup results in the call being routed to the RTX 102 by the originating MSC 104, where the IAM message includes a “*” followed by a number identifying the 1-to-1 Voice SMS service on the RTX 102.

Block 2102 represents the Voice SMS creator, using a handset 120, depositing a voice message with the RTX 102.

Block 2104 represents the RTX 102 sending an SMS message to the recipient notifying them of the voice message, wherein the message includes a number identifying the Voice SMS service on the RTX 102.

Block 2106 represents the recipient replying to the Voice SMS notification using an SMS callback function through the Inbox screen on the handset 120 by highlighting the received Voice SMS notification and selecting the Send key, which results in a call being made to the Voice SMS service on the RTX 102, wherein the Voice SMS service includes an IVR system that allows the recipient to retrieve the voice message deposited by the originator.

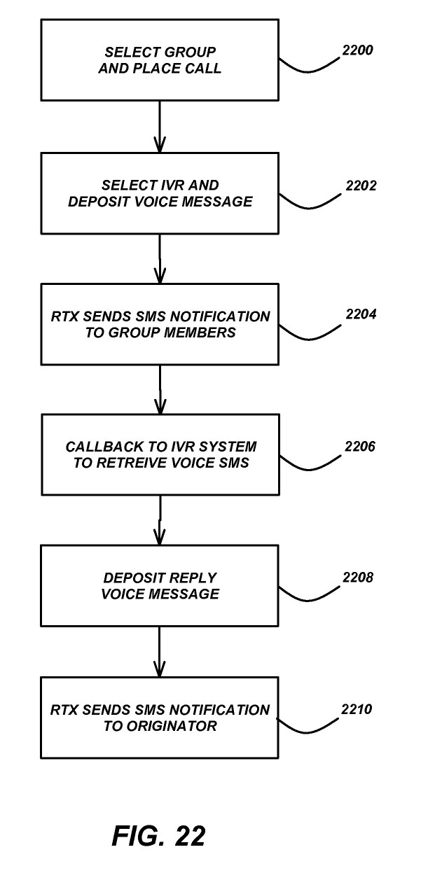

FIG. 22 is a flowchart that illustrates the steps performed in a 1-to-many Voice SMS to a group of recipients, wherein the call is initiated by a clientless user, who uses the assigned number to request the service.

Block 2200 represents the Voice SMS creator, using a handset 120, selecting the assigned group number or typing in the assigned group number, and then calling the assigned group. The call is routed by the originating MSC 104 to the RTX 102, where the IAM message includes a number in the called party number field identifying the Voice SMS service on the RTX 102.

Block 2202 represents the Voice SMS creator, using a handset 120, selecting Voice SMS service via IVR and depositing a voice message with the RTX 102.

Block 2204 represents the RTX 102 sending an SMS message to each recipient notifying them of the voice message, wherein the message includes a number identifying the Voice SMS service on the RTX 102.

Block 2206 represents each recipient selecting the number identifying the Voice SMS service from the SMS message, and selecting the Send key, which results in a call being made to the Voice SMS service on the RTX 102, wherein the Voice SMS service includes an IVR system that allows the recipient to retrieve the voice message deposited by the originator.

Block 2208 represents the recipient choosing to reply to the originator by depositing their own voice message after listening to the originator's voice message.

Block 2210 represents the RTX 102 sending an SMS notification to the originator regarding the voice message deposited by the recipient.

10.2 Voice SMS User Experience—Client Option

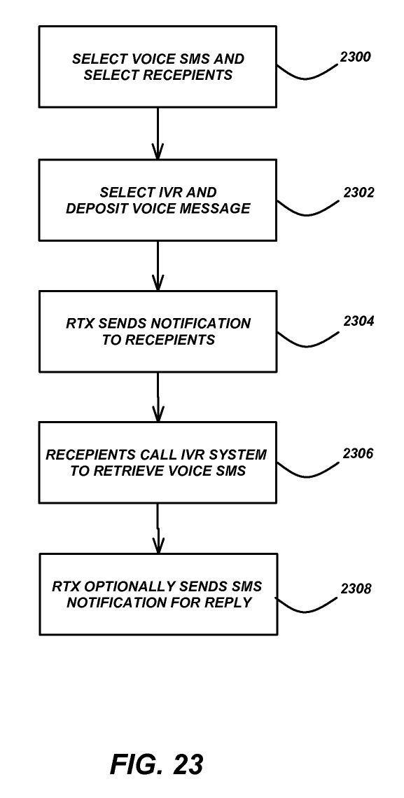

FIG. 23 is a flowchart that illustrates the steps performed when a user invokes Voice SMS from a handset 120 provisioned with a client application.

Block 2300 represents the Voice SMS creator, using a handset 120, selecting a “Voice SMS” option, selecting the contacts, and then pressing the Send key. This sequence results in an SMS message being sent to the RTX 102, along with a call being made to a dedicated Voice SMS number.

Block 2302 represents the Voice SMS creator, using a handset 120, selecting the Voice SMS service via IVR, and depositing a voice message with the RTX 102.

Block 2304 represents the RTX 102 sending an SMS message to each recipient notifying them of the voice message, wherein the message includes a number identifying the Voice SMS service on the RTX 102.

Block 2306 represents each recipient selecting the number identifying the Voice SMS service from the SMS message, and pressing the Send key, which results in a call being made to the Voice SMS service on the RTX 102, wherein the Voice SMS service includes an IVR system that allows the recipient to retrieve the voice message deposited by the originator.

Block 2308 represents the RTX 102 optionally sending an SMS notification to the originator or all members based on the selection, via IVR, by the recipient.

10.3 Call Flows

This section explains the call flows for Voice SMS in the CDMA and GSM networks.

10.3.1 Call Flows for CDMA Network

10.3.1.1 Voice SMS Deposit

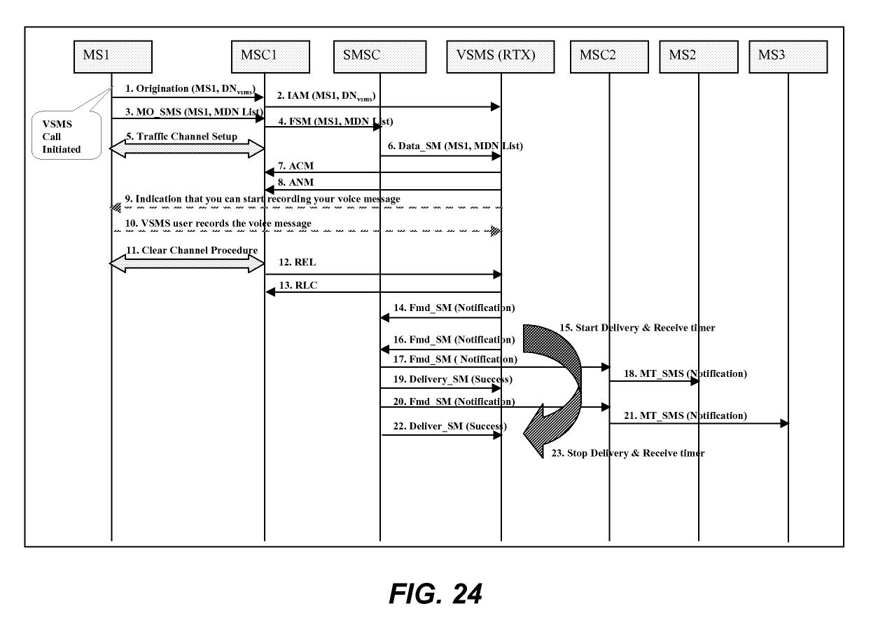

FIG. 24 is a call flow diagram that depicts the Voice SMS deposit without report in a CDMA network. The steps include the following:

1. MS1 makes a Voice SMS call, by sending an SMS message to the RTX. The SMS message contains an MDN list specifying the recipients for the Voice SMS.

2. MSC1 forwards an MO-SMS message to the SMSC.

3. Once MS1 receives the Delivery and Receive (DR) acknowledgement, MS1 originates a call to a preconfigured number, which is dedicated to a particular RTX.

4. Upon receiving the originating message, MSC1 sends an IAM to the RTX.

5. MSC1 establishes a traffic channel to MS1.

6. SMSC routes the MO-SMS to the RTX. (Note that this message may be received by the RTX early than the IAM received by the RTX.)

7. The RTX sends an ACM back to MSC1 immediately.

8. The RTX sends an ANM to MSC1 to establish the bear path between MSC1 and the RTX.

9. The RTX plays an announcement indicating that the user can start recording the voice message.

10. MS1 records the voice message.

11. After the recording is complete, MS1 releases the call, and MSC1 clears the traffic channel between MS1 and the MSC1.

12. MSC1 sends a REL (Release) message to the RTX.

13. Upon receiving the REL from MSC1, the RTX responds RLC (Release Complete) back to MSC1 and clears the resources between MSC1 and the RTX.

14. Based on the recipients listed in the received SMS, the RTX sends an SMS notification to each recipient (i.e. MS2) indicating that there is a voice message waiting for them via the SMSC. Note that the calling party number of the SMS notification is one of the RTX's MDNs. The RTX MDNs are used to ensure that the recipient can call back to the RTX when the recipient receives the SMS notification and uses the call back function.

15. The RTX starts a DR timer.

16. The RTX continue sends an SMS notification to the next recipient (i.e. MS3) indicating that there is a voice message waiting for MS3 via the SMSC.

17. The SMSC locates the MS2 and forwards the SMS notification message to MSC2 where MS2 is registered.

18. MSC2 deliveries the SMS notification message to MS2.

19. The SMSC returns the DR acknowledgement to the RTX regarding the status of SMS delivery to MS2.

20. The SMSC locates the MS3 and forwards the SMS notification message to MSC3 where MS3 is registered.

21. MSC2 deliveries the SMS notification message to MS3.

22. The SMSC returns the DR acknowledgement to the RTX regarding the status of SMS delivery to MS3.

23. The RTX stops the DR timer after receiving all the DR acknowledgements for all SMS notification messages sent.

10.3.1.2 Voice SMS Retrieval Followed by a Reply all Option

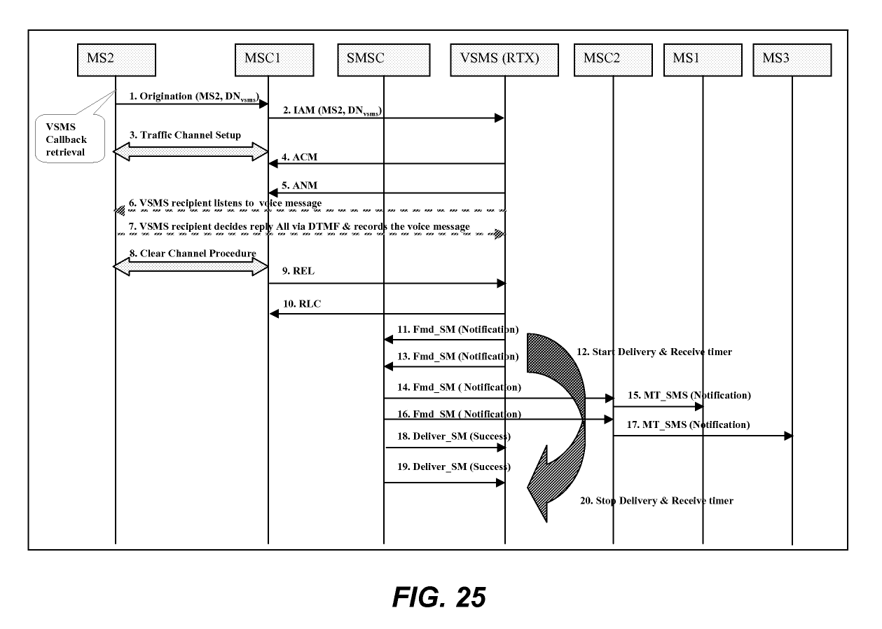

FIG. 25 is a call flow diagram that depicts the Voice SMS retrieval followed by a Reply All option in a CDMA network. The steps include the following:

1. Once the Voice SMS recipient receives the SMS notification, the Voice SMS recipient can use the SMS callback function to originate a call in order to retrieve the voice message. Note that the calling party number for the SMS received is one of the RTX's MDNs. This RTX MDN allows the network to route the call back to the RTX, which initiated the SMS Notification to the Voice SMS recipient.

2. Upon receiving the originating message, MSC1 sends an IAM to the RTX.

3. MSC1 also establishes the traffic channel to MS1.

4. The RTX sends an ACM back to MSC1 immediately.

5. The RTX sends an ANM to MSC1 to establish a bearer path between MSC1 and the RTX.

6. MS2 listens to the voice message.

7. After listening to the voice message, MS2 decides to respond by selecting a “reply all” option via DTMF and starts recording a voice message.

8. After the recording the voice message, MS2 releases the call, and MSC1 clears the traffic channel between MS2 and MSC1.

9. MSC1 sends a REL message to the RTX.

10. Upon receiving the REL message from MSC1, the RTX responds RLC back to the MSC1 and clears the resources between MSC1 and the RTX.

11. The RTX sends an SMS notification message to the originator (i.e. MS1) indicating that there is a voice message waiting for MS1 via the SMSC. Note that the calling party number of the SMS notification is one of the RTX's MDNs. The RTX MDN is used to ensure that the recipient can call back to the RTX when the recipient receives the SMS notification and uses the call back function.

12. The RTX starts a DR timer.

13. The RTX also sends an SMS notification message to the other recipient (i.e. MS3) indicating that there is a voice message waiting for MS3 via the SMSC.

14. The SMSC locates the MS1 and forwards the SMS notification message to MSC2.

15. MSC2 deliveries the SMS notification to MS1.

16. The SMSC locates the MS3 and forwards the SMS notification message to MSC2.

17. MSC2 deliveries the SMS notification message to MS3.

18. The SMSC returns the DR acknowledgement to the RTX regarding the status of SMS delivery to MS1.

19. The SMSC returns the DR acknowledgement to the RTX regarding the status of SMS delivery to MS3.

20. The RTX stops the DR timer after receiving all the DR acknowledgements for all SMS notification messages sent.

10.3.2 Call Flows for GSM Network

In this section, it is assumed that the network is configured as SMSC-Bypass. Therefore, there is no SMSC Functional Entity explicitly shown in the figures. Also, for simplicity, the HLR Functional Entity is omitted.

10.3.2.1 Voice SMS Deposit

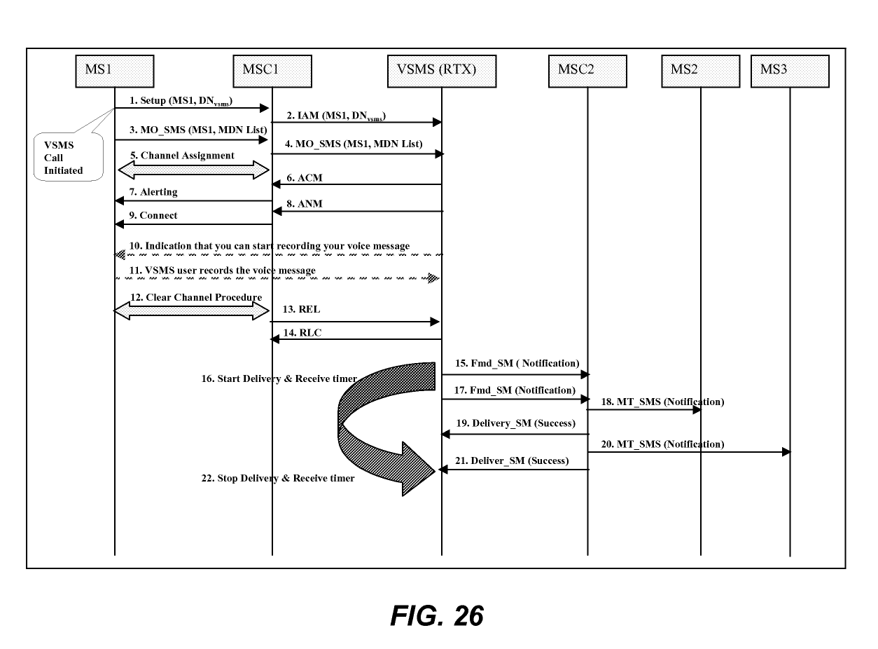

FIG. 26 is a call flow diagram that depicts the Voice SMS deposit without report in a GSM network. The steps include the following:

1. MS1 makes a Voice SMS call by sending an SMS message to the RTX. The SMS message contains an MDN list specifying the recipients for this Voice SMS.

2. MSC1 forwards the MO-SMS message to the SMSC.

3. Once MS1 receives the DR acknowledgement, MS1 originates a call to a preconfigured number, which is dedicated to a particular RTX.

4. Upon receiving the Setup message, MSC1 sends an IAM to the RTX.

5. MSC1 also establishes a traffic channel to MS1.

6. The RTX sends an ACM back to MSC1 immediately.

7. Upon receiving the ACM from the RTX, MSC1 sends an Alerting message to MS1.

8. The RTX sends an ANM to MSC1 to establish a bearer path between MSC1 and the RTX.

9. Upon receiving the ANM from the RTX, MSC1 sends a Connect message to MS1.

10. The RTX plays an announcement indicating that the user can start recording the voice message.

11. MS records the voice message.

12. After the recording is complete, MS1 releases the call, and MSC1 clears the traffic channel between MS1 and MSC1.

13. MSC1 sends a REL message to the RTX.

14. Upon receiving the REL from MSC1, the RTX responds RLC back to MSC1 and clears the resources between MSC1 and the RTX.

15. Based on the recipients in the received SMS, the RTX locates the recipients (i.e. MS2) and then sends an SMS notification to MS2 indicating that there is a voice message waiting for MS2 via MSC2.

16. The RTX starts a DR timer.

17. The RTX locates the next recipient (i.e. MS3), and then sends an SMS notification to MS3 indicating that there is a voice message waiting for MS3 via the SMSC.

18. MSC2 deliveries the SMS notification message to MS2.

19. MSC2 returns the DR acknowledgement to RTX regarding the status of SMS delivery to MS2.

20. MSC2 deliveries the SMS notification message to MS3.

21. MSC2 returns the DR acknowledgement to the RTX regarding the status of SMS delivery to MS3.

22. The RTX stops the DR timer after receiving all the DR acknowledgements for all SMS notification messages sent.

10.3.2.2 Voice SMS Retrieval Following by Reply all Option

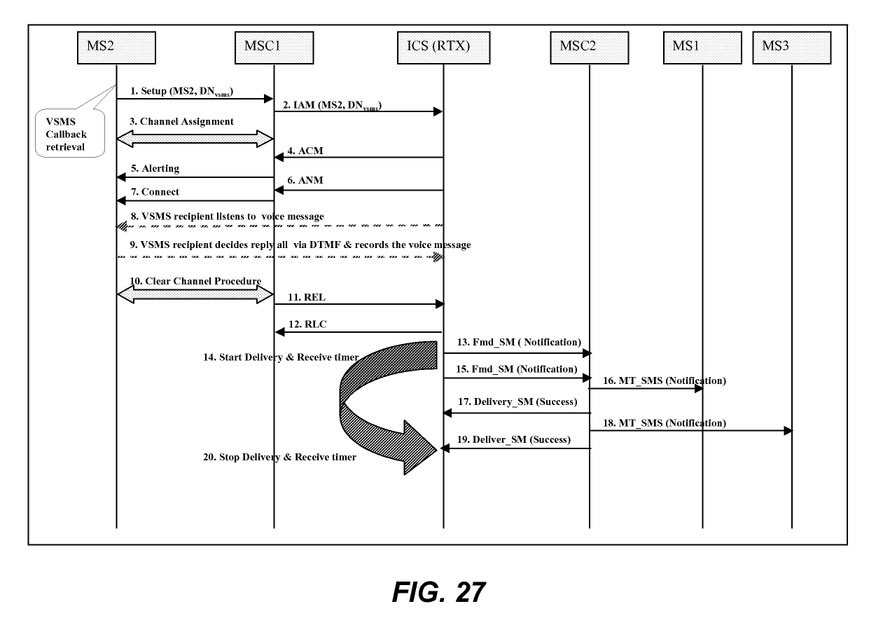

FIG. 27 is a call flow diagram that depicts the Voice SMS retrieval followed by a Reply All option in a GSM network. The steps include the following:

1. Once the Voice SMS recipient receives the SMS notification, the Voice SMS recipient can use the SMS callback function to originate a call in order to retrieve the voice message. Note that the calling party number for the SMS received is one of the MDNs for the RTX. This RTX MDN allows the network to route the call back to the RTX, which initiated the SMS notification to the Voice SMS recipient.

2. Upon receiving the Setup message, MSC1 sends an IAM to the RTX.

3. MSC1 also establishes a traffic channel to MS2.

4. The RTX sends an ACM back to MSC1 immediately.

5. Upon receiving the ACM from the RTX, MSC1 sends an Alerting message to MS2.

6. The RTX sends an ANM to MSC1 to establish a bearer path between MSC1 and the RTX.

7. Upon receiving the ANM from the RTX, MSC1 sends a Connect message to MS2.

8. MS2 listens to the voice message.

9. After listening to the voice message, MS2 decides to respond by selecting a “reply all” option via DTMF and starts recording a voice message.

10. After completing the recording, MS2 releases the call, and MSC1 clears the traffic channel between MS2 and MSC1.

11. MSC1 sends a REL message to RTX.

12. Upon receiving the REL from MSC1, the RTX responds RLC back to MSC1 and clears the resources between MSC1 and the RTX.

13. The RTX locates the originator (i.e. MS1) by querying the HLR, and then sends an SMS notification message to MS1 indicating that there is a voice message waiting for MS1 via the SMSC.

14. The RTX starts a DR timer.

15. The RTX also locates other recipients (i.e. MS3) by querying the HLR, and then sends an SMS notification message to MS3 indicating that there is a voice message waiting for MS3 via the SMSC.

16. MSC2 deliveries the SMS notification to MS1.

17. MSC2 returns the DR acknowledgement to the RTX regarding the status of SMS delivery to MS1.

18. MSC2 deliveries the SMS notification message to MS3.

19. MSC2 returns the DR acknowledgement to the RTX regarding the status of SMS delivery to MS3.

20. The RTX stops the DR timer after receiving all the DR acknowledgements for all SMS notification messages sent.

### 11 Email2Conference

The Email2Conference service enables initiation of a mobile conference request from any standard email/calendar client that runs on desktop computers or mobile handsets 120. It integrates with RTX 102 conference facility and notifies the mobile handsets 120 of conference participants so that they can join from the mobile handset 120 directly.

The Email2Conference service is best suitable in enterprise environments where a conference can be initiated using corporate email accounts. Participants receive dial-in/dial-out notifications on their respective mobiles handsets 120. Participants or the moderator can join the call when the RTX 102 dials out at the scheduled time or they can rejoin by just pressing the “Send” key after selecting the conference number.

A user can send an email or initiate a calendar request to a well advertised and fixed conference email address to initiate a conference from a desktop email client or mobile email client. A user can initiate this request from any email client running on any device/machine that supports the calendar standard format of IETF RFC 2445 (e.g., the MICROSOFT OUTLOOK email client, the BLACKBERRY email client, the LOTUS email client, etc.).

The participants can be addressed in the “To” or “cc” fields as lists using their email address or their mobile phone 120 number followed by “@email-address.com” where email-address.com is an advertised address for this service. A user also can set the date and time via their existing calendar to schedule a conference. For the dial-in or dial out option of the scheduled conference, the “Subject” field of the calendar is used in order to obtain the nature of call setup method. A user can manage the scheduled conference such as add/delete participants, change time or cancel the schedule.

Preferably, the RTX 102 constantly monitors for emailed calendar requests on a well-known and advertised email address, parses the calendar requests upon receiving the emailed calendar request in order to identify the originator and participants of the conference, the date and time, and the dial-in or dial out option. The RTX 102 can also map email addresses to mobile phone numbers using an internal database, so that an SMS notification message can be sent to the originator and participants.

### 12 Management of a Limited Pool of Routable Numbers

This section provides a description of the central concept of management of a limited pool of routable numbers to provide AGS calls to an arbitrarily large number of users. This description is provided with reference to FIG. 1.

12.1 Solution Overview

The present invention provides a method for allocating one number from a pool of network routable numbers for each participant subscriber in a particular session of group-based communications services, such that each number uniquely identifies a session context for a given participant subscriber with an identifier. With this allocation strategy, group-based communications services becomes viral and interactive as any addressable number in any type of network (e.g., PLMN/PSTN/IP networks) can be a participant to a group-based communications services sessions of voice, video and text hosted by the RTX 102. Allocation and management of the limited pool of network routable numbers is important as these are scarce resources, yet service providers would like to provide group-based communications services to an arbitrarily large number of users.

12.2 Solution Description

1. Any group-based communications service in the RTX 102 starts with a session.

2. A session has a context and list of participants using MS's 120. Each participant MS 120 in a session can have any identifier from any type of network. For example, the participant MS 120 could have a number, which uniquely identifies the MS 120 in PSTN networks 106 and PLMN networks 100, or an IP address, which uniquely identifies the MS 120 in an IP network 124, 130.

3. Participants of a session can invoke multiple transactions within a session. Moreover, any participant can be a member of multiple sessions where the participant list can be different for each session.

4. Each transaction is one instance of a group-based communications service of any combination of voice, video and text.

5. Since one particular participant can be involved in multiple transactions across sessions (as part of different groups) spread over multiple RTX's 102 in a network 100, the challenge is to identify the transaction uniquely so that session context can be retrieved when the participant wants to communicate with other members who have formed the session.

6. The problem is solved by allocating a unique identifier per transaction per participant per session. The identifier can be selected from a limited pool of numbers and re-used for any participant across sessions hosted in a particular RTX 102.

7. The identifier can be routable in a PLMN/PSTN/IP network 100, 106, 124, 130, so that the group-based communications services can be accessible from any device (e.g. MS 120, PSTN end point, SIP device or IP end point).

8. Since the number is allocated from a pool, the unique service transactions that a participant can have are limited only by the numbers available in pool. The larger the pool, the more transactions a participant can have, without the number being recycled.

9. The above procedure can be scaled by allocating a specific number pool for each group-based communications service. For example, if there are four types of distinct group-based communications services, four different pools can be assigned to the system.

12.3 Application Example

The above method can be applied to one type of group-based communications service where any MS 120 (with a unique addressable number) can participate in group-based text chat service from respective end points of the network 100. The following scenarios take place in the context of group-based text communications services across any end point.

1. An authorized user initiates a group-based text chat service, as a text interactive communications service, with the RTX 102. The user sends the list of intended participants, who can belong to any type of network.

2. The RTX 102 creates a session and allocates a transaction identifier for each participant from an assigned number pool, which may or may not be specific to service. For example, A, B, C and D are participants in the session with each having an addressable number Ea, Eb, Ec and Ed in their respective networks. The RTX 102 allocates the numbers P1, P2, P3 and P4, respectively, for a first transaction. Thus, A, B, C and D receive text messages with the transaction numbers P1, P2, P3 and P4, respectively.

3. When C wants to communicate within the group by sending a reply to an original message, it can use P3 to send a message. From a unique combination of P3 and Ec, the RTX 102 can identify the session context and retrieve information on other members of the session. The RTX 102 treats this as a new transaction of the session and allocates, for example, P2, P3, P4, P1 for A, B, C, D, respectively. Hence, now A has two transactions with P1 and P2, which can be used any time to initiate interactive communication within the session.

4. The numbers can be re-used for each participant and can remain unique for a participant as long as the numbers in the pool for that participant are not exhausted.

### 13 Prepaid Billing Solution for Mobile Conference and PTT Services

The Prepaid Billing Solution service enables a real-time billing mechanism for a prepaid subscriber. The Prepaid Billing Solution is applicable to both mobile conferences and PTT services.

The primary benefits of the Prepaid Billing Solution are:
To bill prepaid subscribers real-time for the mobile conference and PTT services, and
To reuse the existing operator infrastructure to perform this billing.

13.1 Mobile Conference Call Flow Description

This service works with a client application in the handset 120 and the RTX 102.
The RTX 102 terminates signaling on STP and bearer connectivity on the GMSC 104.
The subscriber can make a conference call by selecting list of contacts on the handset 120.
The following call flow illustrates the steps performed:
   A, B, C and D are subscribers.
   Subscriber A has a Conference-Client installed on the handset 120 and A is configured on the RTX 102.
   Subscriber A launches the Conference-Client, selects B, C, and D, and initiates a conference call.
   The Conference-Client establishes a call to the number for the RTX 102, and the MSC 104 routes the call to the RTX 102. In this way, the Conference-Client is connected to the RTX 102.
   The Conference-Client sends an SMS to the RTX 102 having the mobile numbers of group members B, C and D in the SMS. Based on this SMS, the RTX 102 terminates the legs to B, C and D.
   The RTX 102 terminates the legs towards, B, C and D via the GMSC 104.
   The RTX 102 bridges the call between A, B, C and D.
The two different Prepaid Billing Solution for the Mobile Conference are:
   Option 1: Prefix based solution, and
   Option 2: Charging Number based solution.

13.2 PTT Call Flow Description

This service works with a client in the handset 120 and the RTX 102.
The RTX 102 terminates signaling on STP and bearer connectivity on the GMSC 104.
The subscriber can create groups, and each group is allocated a unique group ID by the RTX 102.
Subscribers can make a PTT call to a group of people and talk in simplex mode. At any given point in time, one participant speaks others listen. When the floor is available, the floor can be occupied by anybody.
The following call flow illustrates the steps performed:
   A, B, C and D are subscribers.
   Subscriber A creates “Sales Group” with B, C and D as members.
   Subscriber A selects the Sales Group and press the PTT button on the handset 120.
   The PTT-Client on A's handset 120 dials the following number: RoutingDelimeter+TypeofCall+GroupIndex
   The serving MSC 104 initiates an InitialDP [DP2 based on Routing Delimiter] with dialed digits as [RoutingDelimeter+TypeofCall+GroupIndex] towards the RTX 102.
   The RTX 102 sends a connect message back to the originating MSC 104 with the number of the RTX 102.
   The originating MSC 104 sends an IAM towards the RTX 102. In this way, the handset 120 for Subscriber A is connected to the RTX 102.
   The RTX 102 dials out the legs towards B, C, D as follows via the GMSC 104:
      IAM [Calling=MSISDN of A+44, Called=MSISDN of B, Charging Number=A]
      IAM [Calling=MSISDN of A+44, Called=MSISDN of C, Charging Number=A]
      IAM [Calling=MSISDN of A+44, Called=MSISDN of C, Charging Number=A]
   The RTX 102 bridges the call between A, B, C and D.
Real Time prepaid billing option for PTT is:
   Option2: Charging Number based solution

13.3 Prefix Based Billing Solution for Mobile Conference

The following call flow describes Option1, namely the prefix-based billing solution for a mobile conference, which is applicable to prepaid subscribers. Specifically, in this example, Subscriber A is prepaid subscriber and Subscriber A initiates a conference call to B, C, and D.

1. Subscriber A selects B, C and D and initiates the conference call. The client application on Subscriber A's handset 120 establishes a call to the number of the RTX 102.

2. The originating MSC 104 routes the call towards the RTX 102. Before routing it to the RTX 102, the MSC 104 identifies Subscriber A as a prepaid subscriber by putting a prefix [111] on the number of the RTX 102.

3. The client on the handset 120 forms an SMS with the numbers for B, C and D, and sends the SMS to the RTX 102 via the GMSC 104.

4. The RTX 102 reads the SMS and initiates the terminating legs towards B, C and D. The RTX 102 identifies Subscriber A as a prepaid subscriber based on the prefix [111] of the number received in the incoming IAM. If Subscriber A is prepaid, then the RTX 102 puts the same prefix [111] on the called party numbers in all IAMs sent to the GMSC 104 for all terminating legs. For example, if Subscriber A is prepaid, then the terminating legs are dialed out as: A to 111+B, A to 111+C and A to 111+D.

5. Based on the prefix [111], the GMSC 104 identifies Subscriber A as a prepaid subscriber, removes the prefix [111] from the number, and initiates a session with a prepaid server handling Subscriber A. The GMSC 104 repeats this for all the terminating legs and, as a result, Subscriber A is billed for all of the terminating legs simultaneously.

13.4 Charging Number Based Billing for Mobile Conference

The following call flow describes Option2, namely the charging number based billing solution for a mobile conference, which is applicable to (real-time) billing subscribers. Specifically, in this example, Subscriber A is a prepaid subscriber and Subscriber A initiates a conference call to B, C, and D.

1. Subscriber A selects B, C and D and initiates the conference call. The client on the handset 120 of Subscriber A establishes a call to the number for the RTX 102.

2. The originating MSC 104 routes the call towards the RTX 102. Before routing the call to the RTX 102, the MSC 104 identifies Subscriber A as a billing subscriber and puts a prefix [111] to the number f the TX 102.

3. The client on the handset 120 forms an SMS with the numbers for B, C and D, and sends the SMS to the RTX 102 via the GMSC 104.

4. The RTX 102 receives the SMS, and initiates the terminating legs towards B, C and D. The RTX 102 identifies Subscriber A as a billing subscriber based on the prefix [111] of the number received in the incoming IAM. While dialing the terminating legs, the RTX 102 enters the “Charging Number” in the IAM as the number of Subscriber A:
Leg1 from RTX 102 to GMSC 104 is IAM (Calling=A, Called=B, Charging Number=A),
Leg2 from RTX 102 to GMSC 104 is IAM (Calling=A, Called=C, Charging Number=A), and
Leg3 from RTX 102 to GMSC 104 is IAM (Calling=A, Called=D, Charging Number=A).

5. The GMSC 104 analyzes the charging number field in the IAM and, since the Charging Number [A] is a billing subscriber, the GMSC 104 initiates an “IN-Session” with the billing server for Subscriber A. The GMSC 104 repeats this for all the legs and, as a result, Subscriber A is billed for all of the terminating legs simultaneously.

13.5 Charging Number Based Billing for PTT

The following call flow describes Option2, namely the charging number based billing solution for a PTT, which is applicable to (real-time) billing subscribers. Specifically, in this example, Subscriber A is a prepaid subscriber and Subscriber A initiates a PTT call to B, C, and D.

1. Subscriber A selects B, C and D, and initiates the PTT call. The client on the handset 120 for Subscriber A establishes a call to: RD+CallType+GroupIndex. [RD=4-digits, Call Type=2-digits, GroupIndex=2 digits].

2. In the originating call setup, the following steps are performed:
a. The serving MSC 104 initiates an InitialDP [DP2 based on Routing Delimiter] with dialed digits as [RoutingDelimeter+TypeofCall+GroupIndex] towards the RTX 102.
b. The RTX 102 sends a connect message back to the originating MSC 104 with the number of the RTX 102.
c. The originating MSC 104 sends the IAM towards the RTX 102.

3. This call reaches the serving MSC 104 and the serving MSC 104 does a “B-Party” analysis and routes the call to the RTX 102.

4. The RTX 102 receives the dial digits in the received IAM, and initiates the terminating legs towards B, C and D. While dialing the terminating legs, the RTX 102 determines whether Subscriber A is a billing subscriber and fills the “Charging Number” in the IAM:
a. Leg1 from the RTX 102 to the GMSC 104 is IAM (Calling=A+33, Called=B, Charging Number=A),
b. Leg2 from the RTX 102 to the GMSC 104 is IAM (Calling=A+33, Called=C, Charging Number=A), and
c. Leg3 from the RTX 102 to the GMSC 104 is IAM (Calling=A+33, Called=D, Charging Number=A).

5. The GMSC 104 analyzes the charging number field in the IAM and, since the Charging Number [A] is a billing subscriber, the GMSC 104 initiates an “IN-Session” with the billing server for Subscriber A. The GMSC 104 repeats this for all the terminating legs and, as a result, Subscriber A is billed for all the terminating legs simultaneously.

### 14 Conclusion

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. An apparatus for providing advanced voice services in a mobile phone network, comprising:
a mobile phone network for making calls between mobile phones, wherein the calls are initiated by call setup and in-band signaling within the mobile phone network and voice frames for the calls are switched between the mobile phones by at least one mobile switching center across bearer paths in the mobile phone network; and
a real-time exchange that interfaces to at least one mobile switching center in the mobile phone network to provide the advanced voice services therein, the advanced voice services including a Scheduled Conference service, wherein an originator mobile phone can schedule a conference call with a group of other participant mobile phones at a predetermined date and time;
both the real-time exchange and the mobile phones that use the Scheduled Conference service communicate with each other using the call setup and in-band signaling within the mobile phone network, and the real-time exchange switches the voice frames for the conference call between the mobile phones across the bearer paths and through at least one mobile switching center in the mobile phone network.

2. The apparatus of claim 1, wherein the Scheduled Conference service includes a Dial-Out mode of operation where the real-time exchange dials out the call to the mobile phones and bridges the conference call between the mobile phones.

3. The apparatus of claim 1, wherein the Scheduled Conference service includes a Dial-In mode of operation where the mobile phones dial in to a conference bridge number and the real-time exchange bridges the conference call between the mobile phones.

4. The apparatus of claim 1, wherein the real-time exchange sends a message to each participant and originator with the conference call's details.

5. The apparatus of claim 4, wherein the message includes a conference bridge number.

6. The apparatus of claim 1, wherein the Scheduled Conference service includes a rejoin number, such that a participant is able to use the rejoin number to rejoin the conference call when the conference call is dropped.

7. The apparatus of claim 1, wherein the Scheduled Conference service is initiated by an email message sent to the real-time exchange.

8. The apparatus of claim 1, wherein a real-time billing mechanism is provided for a subscriber for the Scheduled Conference service.

9. An apparatus for providing advanced voice services in a mobile phone network, comprising:
a mobile phone network for making calls between mobile phones, wherein the calls are initiated by call setup and in-band signaling within the mobile phone network and voice frames for the calls are switched between the mobile phones by at least one mobile switching center across bearer paths in the mobile phone network; and
a real-time exchange that interfaces to at least one mobile switching center in the mobile phone network to provide the advanced voice services therein, the advanced voice services including a Reservationless Conference service, wherein an originator mobile phone can set up a conference call via the real-time exchange and communicate a conference bridge number and password to participants of the conference call;
both the real-time exchange and the mobile phones that use the Reservationless Conference service communicate with each other using the call setup and in-band signaling within the mobile phone network, and the real-time exchange switches the voice frames for the conference call between the mobile phones across the bearer paths and through at least one mobile switching center in the mobile phone network.

10. The apparatus of claim 9, wherein the real-time exchange sends a message to each participant and originator with the conference call's details.

11. The apparatus of claim 10, wherein the message includes a conference bridge number.

12. An apparatus for providing advanced voice services in a mobile phone network, comprising:
a mobile phone network for making calls between mobile phones, wherein the calls are initiated by call setup and in-band signaling within the mobile phone network and voice frames for the calls are switched between the mobile phones by at least one mobile switching center across bearer paths in the mobile phone network; and
a real-time exchange that interfaces to at least one mobile switching center in the mobile phone network to provide the advanced voice services therein, the advanced voice services including an Instant Conferencing service, wherein an originator mobile phone sets up a group of participant mobile phones via the real-time exchange, the real-time exchange assigns a dial out number to the group and the originator mobile phone initiates a conference call with the group of participant mobile phones via the real-time exchange by dialing the dial out number, where the real-time exchange dials out to the participant mobile phones and bridges the conference call between the mobile phones.
both the real-time exchange and the mobile phones that use the Instant Conferencing service communicate with each other using the call setup and in-band signaling within the mobile phone network, and the real-time exchange switches the voice frames for the conference call between the mobile phones across the bearer paths and through at least one mobile switching center in the mobile phone network.

13. The apparatus of claim 12, wherein the group is set up via Internet access, Short Message Service (SMS), Wireless Access Protocol (WAP), or an operator.

14. An apparatus for providing advanced voice services in a mobile phone network, comprising:
a mobile phone network for making calls between mobile phones, wherein the calls are initiated by call setup and in-band signaling within the mobile phone network and voice frames for the calls are switched between the mobile phones by at least one mobile switching center across bearer paths in the mobile phone network; and
a real-time exchange that interfaces to at least one mobile switching center in the mobile phone network to provide the advanced voice services therein, the advanced voice services including Group Short Message Service (GSMS), wherein an originator mobile phone sets up a group of participant mobile phones via the real-time exchange, and the originator mobile phone simultaneously sends a text message to all of the participant mobile phones via the real-time exchange.
both the real-time exchange and the mobile phones that use the Group Short Message Service communicate with each other using the call setup and in-band signaling within the mobile phone network, and the real-time exchange switches the frames for the text message between the mobile phones across the bearer paths and through at least one mobile switching center in the mobile phone network.

15. The apparatus of claim 14, wherein one or more of the participant mobile phones reply to the text message and the reply is sent by the real-time exchange to the originator mobile phone or to all of the participant mobile phones.

16. An apparatus for providing advanced voice services in a mobile phone network, comprising:
a mobile phone network for making calls between mobile phones, wherein the calls are initiated by call setup and in-band signaling within the mobile phone network and voice frames for the calls are switched between the mobile phones by at least one mobile switching center across bearer paths in the mobile phone network; and
a real-time exchange that interfaces to at least one mobile switching center in the mobile phone network to provide the advanced voice services therein, the advanced voice services including a Voice Short Message Service (VSMS), wherein an originator mobile phone sets up a group of participant mobile phones via the real-time exchange, and the originator mobile phone leaves a single voice message for all of the participant mobile phones via the real-time exchange without calling the participant mobile phones.
both the real-time exchange and the mobile phones that use the Voice Short Message Service communicate with each other using the call setup and in-band signaling within the mobile phone network, and the real-time exchange switches the voice frames for the voice message between the mobile phones across the bearer paths and through at least one mobile switching center in the mobile phone network.

17. The apparatus of claim 16, wherein the real-time exchange sends a text message to the participant mobile phones notifying them of the voice message.

18. The apparatus of claim 16, wherein the real-time exchange dials out to the participant mobile phones notifying them of the voice message.

19. The apparatus of claim 16, wherein the participant mobile phones call back to the real-time exchange to retrieve the voice message.

20. The apparatus of claim 19, wherein one or more of the participant mobile phones reply to the voice message by leaving a reply voice message with the real-time exchange for the originator mobile phone or for all of the participant mobile phones.

21. An apparatus for providing advanced voice services in a mobile phone network, comprising:
a mobile phone network for making calls between mobile phones, wherein the calls are initiated by call setup and in-band signaling within the mobile phone network and voice frames for the calls are switched between the mobile phones by at least one mobile switching center across bearer paths in the mobile phone network; and
a real-time exchange that interfaces to at least one mobile switching center in the mobile phone network to provide the group-based communications services therein, wherein the real-time exchange manages a limited pool of network routable numbers that are used to provide the group-based communications services by allocating one number from the limited pool of network routable numbers for each participant in a particular session of the group-based communications services, such that each allocated number uniquely identifies a session context for a given participant;
both the real-time exchange and the mobile phones that use the group-based communications services communicate with each other using the call setup and in-band signaling within the mobile phone network, and the real-time exchange switches the voice frames for the group-based communications services between the mobile phones across the bearer paths and through at least one mobile switching center in the mobile phone network.
